(19) United States
(12) Patent Application Publication
(10) Pub. No.: US 2014/0096967 A1
(43) Pub. Date: Apr. 10, 2014

(54) SALT-TOLERANT ANIONIC SURFACTANT COMPOSITIONS FOR ENHANCED OIL RECOVERY (EOR) APPLICATIONS

(71) Applicant: Board of Regents, The University of Texas System, Austin, TX (US)

(72) Inventors: Mukul M. Sharma, Austin, TX (US); Bo Gao, Austin, TX (US)

(73) Assignee: Board of Regents, The University of Texas System, Austin, TX (US)

(21) Appl. No.: 13/963,460

(22) Filed: Aug. 9, 2013

Related U.S. Application Data
(60) Provisional application No. 61/709,785, filed on Oct. 4, 2012.

(51) Int. Cl. C09K 8/584; E21B 43/16

(52) U.S. Cl. CPC C09K 8/584; E21B 43/16
USPC 166/305.1; 507/238; 507/254; 507/255; 507/259; 507/252; 507/261; 507/267; 507/262; 507/263; 554/96

(57) ABSTRACT

The present invention includes compositions and methods for using an anionic surfactant composition for treating a hydrocarbon-bearing formation or a reservoir, of formula (I):

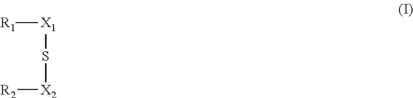

wherein R1 and R2 are identical or different and may independently be alkyl, alkenyl, alkynyl, alkylene, aryl, propylene oxide, ethylene oxide or hydrogen groups in a straight or branched chain with 16 or more carbon atoms, X1 and X2 are identical or different and are selected from the group consisting of phosphate, sulfate, carboxylate, sulfonate or other suitable anionic groups, S is a spacer group selected from short or long arkyl, alkenyl, alkynyl, alkylene, stilbene, polyethers, and other suitable aliphatic or aromatic groups comprising 2 to 12 carbon atoms.

### CROSS-REFERENCE TO RELATED APPLICATIONS

This application claims priority to U.S. Provisional Application Ser. No. 61/709,785, filed Oct. 4, 2012, the entire contents of which are incorporated herein by reference.

### TECHNICAL FIELD OF THE INVENTION

The present invention relates in general to the field of oil recovery, and more particularly, to a novel class of anionic surfactants for enhanced oil recovery (EOR) applications having a higher salt-tolerance, a higher surface activity, and under certain conditions greater viscosity than conventional anionic surfactants used in EOR.

### STATEMENT OF FEDERALLY FUNDED RESEARCH

None.

### BACKGROUND OF THE INVENTION

Without limiting the scope of the invention, its background is described in connection with methods of manufacture and use of anionic surfactants for oil recovery applications.

U.S. Pat. No. 5,952,290 issued to Li and Tracy (1999) discloses a new, improved class of anionic Gemini surfactants consisting of two hydrophilic groups and two hydrophobic moieties joined by a bridge that possess improved surfactant functionalities yet may be characterized as mild for use in personal care products and environmentally benign. These compounds may be represented by the general structural formula shown below:

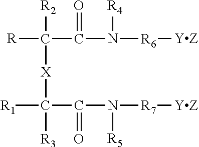

wherein R, R₁, R₂, and R₃ are selected from the group consisting of straight or branched chain C₁ to C₂₂ alkyl, aryl or hydrogen, and each R moiety can be the same or different; R₄ and R₅ are selected from the group comprising a straight or branched chain C₁ to C₆ alkyl with the further proviso that when either is a C₆ it may exist as a cyclohexyl ring; R₆ and R₇ are selected from the group consisting of straight or branched chain C₂ to C₆ alkyl or aryl with the further proviso that R₆ and R₇ may be the same or different and wherein X is selected from the group comprising —S—, —S—S—, -D₁-R₈-D- or —R₈-D₁-R₈— wherein R₈ is a straight or branched chain C₁ to C₁₀ alkyl or aryl and D₁ is selected from the HI group consisting of —O—, —S—, —S—S—, —SO₂—Y is —PO₄ or —SO₃ and can be the same or different and Z is selected from the group consisting of Na, K, alkali or alkaline earth metals, ammonium, their salts and mixtures thereof.

U.S. Pat. No. 4,976,315 issued to Prukop and Chea (1990) describes methods to increasing the recovery of oil in enhanced oil recovery operations employing anionic surfactant by blending a taurine with said anionic surfactant. According to the '315 patent the added taurine may also increase the salt and divalent ion tolerance of the anionic surfactant.

United States Patent Application Publication No. 2008/0261835 (Berger et al., 2008) describes a process for recovering heavy oil with the steps of: a) injecting into one or more injection wells an aqueous injection fluid containing one or more surfactants designed to form a pseudo-emulsion between the injection fluid and the heavy oil, and, b) recovering the oil from one or more producing wells. According to the Berger invention the process does not require the addition of outside mechanical or thermal energy or solvents to recover the heavy oil and does not form emulsions between the injection fluid and the heavy oil that may be difficult to break when brought to the surface or may cause increased viscosity and injectivity problems within the reservoir.

### SUMMARY OF THE INVENTION

The present invention relates to particular structures of Gemini surfactants that can be used in enhanced recovery of crude oil (EOR) from oil reservoirs. It is also shown that not all Gemini surfactants are suitable for EOR applications as generally claimed by earlier authors. The particular Gemini surfactants described herein can be applied in chemical EOR operations in petroleum reservoirs with very high salinity and/or hardness. The molecules of the present invention are very surface active and have been shown to yield ultra-low interfacial tensions at very low concentrations (10 to 100 times lower concentrations compared to traditional EOR surfactants). In addition they exhibit high viscosity under certain conditions and, therefore, they may be used without any polymer (with the surfactant providing the necessary viscosity). This is in particularly advantageous because polymers become less effective i.e. have a lower viscosity as the salinity increases.

In one embodiment, the present invention includes an anionic surfactant composition for treating a hydrocarbon-bearing formation or a reservoir, wherein the surfactant is sufficiently soluble in water, hard water, hard brine or in solutions of high salinity, can reduce interfacial tension between an aqueous phase and an oil phase to below 0.001 dynes/cm and can be injected into the hydrocarbon-bearing formation of formula (I):

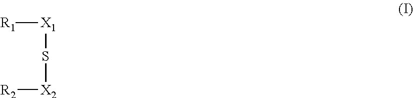

wherein R₁ and R₂ are identical or different and may independently be alkyl, alkenyl, alkynyl, alkylene, aryl, propylene oxide, ethylene oxide or hydrogen groups in a straight or branched chain with 16 or more carbon atoms, X₁ and X₂ are identical or different and are selected from the group consisting of phosphate, sulfate, carboxylate, sulfonate or other suitable anionic groups, S is a spacer group selected from short or long arkyl, alkenyl, alkynyl, alkylene, stilbene, polyethers, and other suitable aliphatic or aromatic groups comprising 2 to 12 carbon atoms. In one aspect, the composition is used alone, in conjunction with a polymer, with another surfactant, or as part of an alkaline surfactant polymer (ASP) composition for treating the hydrocarbon-bearing formation. In another aspect, the composition is used for enhanced oil recovery (EOR), environmental ground water cleanup, and other surfactant based applications. In another aspect, the composition is used to treat the reservoir with salinities of up to about 350,000 ppm. In another aspect, the composition is used to treat the reservoir with salinities of 200 ppm, 500 ppm, 1000 ppm, 5000 ppm, 10,000 ppm, 50,000 ppm, 100,000 ppm, 150,000 ppm, 250,000 ppm, 350,000 ppm. In another aspect, the composition is used to treat the reservoir with a hardness ion concentration of up to about 50,000 ppm. In another aspect, the composition is used to treat in the reservoir with a hardness ion concentration of 200 ppm, 500 ppm, 1000 ppm, 5000 ppm, 10,000 ppm, 50,000 ppm. In another aspect, the composition is thermally stable at temperatures of 200° C. or greater. In another aspect, the composition is thermally stable at temperatures of 50° C., 100° C., 150° C., 200° C. In another aspect, the composition has a formula (n-C₁₈H₃₆)₂(OCH₂CH₂CH₂CH₂O)(OC₂H₄SO₄NO₂. In another aspect, the composition has the formula (n-C₁₈H₃₆)₂(OCH₂CH₂CH₂CH₂O)(OC₂H₄SO₄NA)₂. In another aspect, the composition further comprises one or more additional surfactants selected from the group consisting of anionic, cationic or non-ionic surfactants, branched alkyl benzene sulfonate, linear alkyl benzene sulfonates, alkyl toluene sulfonates, and alkyl xylene sulfonates. In another aspect, the composition further comprises a C₁₆-C₁₈ alkyl benzene sulfonate.

Yet another embodiment of the present invention includes a method of enhanced oil recovery from a hydrocarbon bearing formation or a reservoir comprising the steps of: injecting an anionic surfactant composition of formula (I) having a general formula:

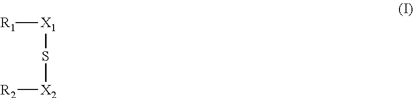

wherein R1 and R2 are identical or different and may independently be alkyl, alkenyl, alkynyl, alkylene, aryl, propylene oxide, ethylene oxide or hydrogen groups in a straight or branched chain with 16 or more carbon atoms, X₁ and X₂ are identical or different and are selected from the group consisting of phosphate, sulfate, carboxylate, sulfonate or other suitable anionic groups, S is a spacer group selected from short or long arkyl, alkenyl, alkynyl, alkylene, stilbene, polyethers, and other suitable aliphatic or aromatic groups comprising 2 to 12 carbon atoms, wherein the anionic surfactant composition is in water, hard water, in solutions of high salinity or hard brine; and recovering the oil following the injection of the anionic surfactant composition. In one aspect, the composition has a formula (n-C₁₈H₃₆)₂(OCH₂CH₂CH₂CH₂O)(OC₂H₄SO₄Na)₂. In another aspect, the composition has a formula (n-C₁₈H₃₆)₂(OCH₂CH₂CH₂CH₂O)(OC₂H₄SO₄Na)₂. In another aspect, the reservoir has salinities of up to about 250,000 ppm. In another aspect, the reservoir has salinities of 200 ppm, 500 ppm, 1000 ppm, 5000 ppm, 10,000 ppm, 50,000 ppm, 100,000 ppm, 150,000 ppm, 250,000 ppm, 350,000 ppm. In another aspect, the reservoir has a hardness ion concentration of up to about 50,000 ppm. In another aspect, the reservoir has a hardness ion concentration of 200 ppm, 500 ppm, 1000 ppm, 5000 ppm, 10,000 ppm, 50,000 ppm. In another aspect, the anionic surfactant composition is thermally stable at reservoir temperatures of 200° C. or greater. In another aspect, the anionic surfactant composition is stable at temperatures of 50° C., 100° C., 150° C., 200° C. In another aspect, the anionic surfactant composition has a formula (n-C₁₆H₂₆)₂(CH₂OCH₂CH₂OCH₂)(OC₂H₄SO₄NO₂. In another aspect, the composition has the formula (n-C₁₈H₃₆)₂(OCH₂CH₂CH₂CH₂O)(OC₂H₄SO₄Na)₂. In another aspect, the composition further comprises an alkyl benzene sulfonate. In another aspect, the composition further comprises a C₁₆-C₁₈ alkyl benzene sulfonate. In another aspect, the composition is used alone, in conjunction with a polymer, with another surfactant, or as part of an alkaline surfactant polymer (ASP) composition for treating the hydrocarbon-bearing formation.

Another embodiment of the present invention is a method of enhanced oil recovery from a hydrocarbon bearing formation or a reservoir comprising the steps of: injecting an anionic surfactant composition of formula (I) having a general formula:

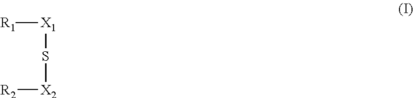

wherein R₁ and R₂ are identical or different and may independently be alkyl, alkenyl, alkynyl, alkylene, aryl, propylene oxide, ethylene oxide or hydrogen groups in a straight or branched chain with 16 or more carbon atoms, X₁ and X₂ are identical or different and are selected from the group consisting of phosphate, sulfate, carboxylate, sulfonate or other suitable anionic groups, S is a spacer group selected from short or long arkyl, alkenyl, alkynyl, alkylene, stilbene, polyethers, and other suitable aliphatic or aromatic groups comprising 2 to 12 carbon atoms, alone, in conjunction with a polymer or as an alkaline-surfactant-polymer formulation (ASP) into the hydrocarbon bearing formation at temperatures of 200° C. or greater, wherein the anionic surfactant composition is in water, hard water, in solutions of high salinity or hard brine; and injecting a polymer “push” solution to recover the oil. In one aspect, the reservoir has salinities of up to about 250,000 ppm. In another aspect, the reservoir has a hardness ion concentration of up to about 50,000 ppm.

Another embodiment of the present invention includes a method of enhanced oil recovery from a hydrocarbon bearing formation or a reservoir comprising the steps of: injecting an anionic surfactant composition having a formula (n-C₁₈H₃₆)₂(OCH₂CH₂ CH₂CH₂O)(OC₂H₄SO₄Na)₂ into the hydrocarbon bearing formation or reservoir, wherein the anionic surfactant composition is in water, hard water, in solutions of high salinity or hard brine; and recovering the oil following the injection of the anionic surfactant composition. In one aspect, the reservoir has salinities of up to about 350,000 ppm. In another aspect, the reservoir has a hardness ion concentration of up to about 50,000 ppm. In another aspect, the anionic surfactant composition is thermally stable at reservoir temperatures of 200° C. or greater. In another aspect, the composition further comprises an alkyl benzene sulfonate.

Yet another embodiment of the present invention includes a composition for treating a hydrocarbon bearing formation or a reservoir comprising: an anionic surfactant composition of formula (I)

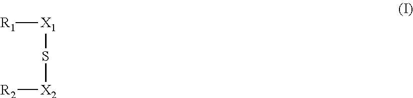

wherein R₁ and R₂ are identical or different and may independently be alkyl, alkenyl, alkynyl, alkylene, aryl, propylene oxide, ethylene oxide or hydrogen groups in a straight or branched chain with 16 or more carbon atoms, X₁ and X₂ are identical or different and are selected from the group consisting of phosphate, sulfate, carboxylate, sulfonate or other suitable anionic groups, S is a spacer group selected from short or long arkyl, alkenyl, alkynyl, alkylene, stilbene, polyethers, and other suitable aliphatic or aromatic groups comprising 2 to 12 carbon atoms; and one or more additional surfactants selected from the group consisting of anionic, cationic or non-ionic surfactants, branched alkyl benzene sulfonate, linear alkyl benzene sulfonates, alkyl toluene sulfonates, and alkyl xylene sulfonates, wherein the anionic surfactant or formula (I), the one or more additional surfactants or both are sufficiently soluble in water, hard water, hard brine or in solutions of high salinity to be injected into a hydrocarbon-bearing formation or reservoir. In one aspect, the composition is used to treat the reservoir with salinities of 200 ppm, 500 ppm, 1000 ppm, 5000 ppm, 10,000 ppm, 50,000 ppm, 100,000 ppm, 150,000 ppm, 250,000 ppm, 350,000 ppm. In another aspect, the composition is used to treat the reservoir with a hardness ion concentration of 200 ppm, 500 ppm, 1000 ppm, 5000 ppm, 10,000 ppm, 50,000 ppm. In another aspect, the composition is thermally stable at temperatures of 200° C. or greater. In another aspect, the composition is adapted for use in enhanced oil recovery (EOR), environmental ground water cleanup, and other surfactant based applications.

Another embodiment of the present invention is a method of enhanced oil recovery from a hydrocarbon bearing sandstone formation or a reservoir comprising the steps of: injecting a surfactant composition comprising an anionic surfactant composition of formula (I):

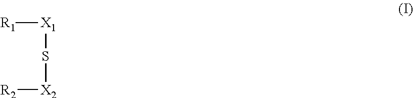

wherein R₁ and R₂ are identical or different and may independently be alkyl, alkenyl, alkynyl, alkylene, aryl, propylene oxide, ethylene oxide or hydrogen groups in a straight or branched chain with 16 to 22 carbon atoms, X₁ and X₂ are identical or different and are selected from the group consisting of phosphate, sulfate, carboxylate, sulfonate or other suitable anionic groups, S is a spacer group selected from short or long arkyl, alkenyl, alkynyl, alkylene, stilbene, polyethers, and other suitable aliphatic or aromatic groups comprising 2 to 12 carbon atoms and one or more additional surfactants selected from the group consisting of anionic, cationic or non-ionic surfactants, branched alkyl benzene sulfonate, linear alkyl benzene sulfonates, alkyl toluene sulfonates, and alkyl xylene sulfonates, wherein the anionic surfactant or formula (I), the one or more additional surfactants or both are sufficiently soluble in water, hard water, hard brine or in solutions of high salinity to be injected into a hydrocarbon-bearing formation or reservoir; and recovering the oil following the injection of the surfactant composition. In another aspect, the reservoir has salinities of 200 ppm, 500 ppm, 1000 ppm, 5000 ppm, 10,000 ppm, 50,000 ppm, 100,000 ppm, 150,000 ppm, 250,000 ppm, 350,000 ppm. In another aspect, the reservoir has a hardness ion concentration of 200 ppm, 500 ppm, 1000 ppm, 5000 ppm, 10,000 ppm, 50,000 ppm. In another aspect, the anionic surfactant composition is thermally stable at reservoir temperatures of 200° C. or greater.

Yet another embodiment of the invention includes a method of selecting an anionic surfactant for optimal oil recovery from a hydrocarbon bearing formation or a reservoir comprising the steps of: identifying a temperature, a salinity and a hardness ion concentration of the hydrocarbon bearing formation or the reservoir; providing an anionic surfactant composition having a formula (I):

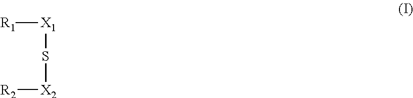

wherein R₁ and R₂ are identical or different and may independently be alkyl, alkenyl, alkynyl, alkylene, aryl, propylene oxide, ethylene oxide or hydrogen groups in a straight or branched chain with 16 to 22 carbon atoms, X₁ and X₂ are identical or different and are selected from the group consisting of phosphate, sulfate, carboxylate, sulfonate or other suitable anionic groups, S is a spacer group selected from short or long arkyl, alkenyl, alkynyl, alkylene, stilbene, polyethers, and other suitable aliphatic or aromatic groups comprising 2 to 12 carbon atoms; and selecting an appropriate R₁, R₂, and S that would impart a suitable hydrophile-lipophile balance (HLB) to the anionic surfactant for optimal oil recovery from the hydrocarbon bearing formation or a reservoir.

### BRIEF DESCRIPTION OF THE DRAWINGS

For a more complete understanding of the features and advantages of the present invention, reference is now made to the detailed description of the invention along with the accompanying figures and in which:

FIG. 1 is a schematic illustration of an offshore oil platform with facilities for injecting chemical solutions into the reservoir for the purpose of flooding the reservoir to enhance the oil recovery according to some embodiments of the present invention.

FIG. 2 shows a chemical structure of sulfate Geminis investigated in this study. Naming scheme: m—number of carbons in the tail; s—number of carbons in the spacer.

FIG. 3 shows the IFT vs. concentration for 14-4-14 and 18-4-18 in 20 weight percent (wt %) NaCl solution at 55° C., with oil phase of dodecane.

FIG. 4 shows the dynamic IFT response for 0.02 wt % 16-4-16 and 18-4-18 in 20 wt % NaCl solution, with oil phase of dodecane.

FIG. 5 shows a comparison of IFT values between systems containing non-equilibrated (filled symbols) phases and pre-equilibrated (open symbols) phases for three Gemini surfactants at different salinities and 55° C., with oil phase of dodecane.

FIG. 6 shows a comparison dynamic IFT response for 0.02 wt % 16-4-16 and 18-4-18 in base solutions (containing 20 wt % NaCl+500 ppm HPAM3330) at 55° C., with oil phase of dodecane.

FIG. 7 shows the impact of alkyl chain length on IFT for 0.02 wt % Geminis in 20 wt % NaCl solution at 55° C., with oil phase of dodecane.

FIG. 8 shows the impact of NaCl concentration on IFT for 0.02 wt % Geminis solutions at 55° C., with oil phase of dodecane.

FIG. 9 shows the impact of CaCl₂ concentration on IFT for 0.02 wt % Geminis in 15 wt % NaCl base solution at 55° C., with oil phase of dodecane.

FIG. 10 shows the effect of alkane carbon number on IFT for 0.02 wt % Geminis in 20 wt % NaCl base solution at 55° C.

FIG. 11 shows the effect of temperature on IFT for 0.02 wt % Gemini aqueous solutions, with oil phase of dodecane.

FIG. 12 shows the synergy of Gemini (0.02 wt %) with Petrostep A1, in 15 wt % NaCl solution at 55° C., with oil phase of dodecane.

FIG. 13 shows the synergism of Gemini (0.02 wt %) with Petrostep A1/M2 (0.01 wt %) at 55° C., with oil phase of dodecane.

FIG. 14 shows test pipettes prepared for 16-4-16 Gemini surfactant (0.2 wt %) phase behavior.

FIG. 15 shows the 16-4-16 adsorption density vs. liquid/solid ratio (LSR).

FIG. 16 shows the 16-4-16 adsorption density and equilibrium concentration vs. equilibration time (LSR: liquid/solid ratio).

FIG. 17 shows the adsorption isotherm for 16-4-16 Gemini surfactant.

FIG. 18 shows adsorption isotherms for 16-4-16 surfactant from experiments and the Langmuir model.

FIG. 19 shows an adsorption isotherm comparison among 16-4-16, STS and S13-C at 25° C.

FIG. 20 shows the effect of salinity on the adsorption of 16-4-16 Gemini.

FIG. 21 shows the effect of alkyl chain length on the adsorption of Geminis m-4-m.

FIG. 22 shows the effect of spacer length on the adsorption of Geminis 16-s-16.

FIG. 23 is a flowchart that was used to identify, in one example, the optimal chemical system subject to reservoir conditions.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

The present invention describes a family of anionic surfactants that has great potential for EOR applications was synthesized and characterized. The unique and versatile structure of these surfactants has endowed them with properties that are attractive for enhanced oil recovery. A detailed experimental study was carried out and is presented here on the oil-water and solid-water interfacial properties of seven novel molecules.

The interfacial properties several anionic surfactants in this series with different hydrophobic tail length of C₁₆ or longer and linking spacer group show systematic trends in interfacial tension and static adsorption density with changes in solution conditions. These molecules showed excellent aqueous stability even in high salinity and hard brines. For Gemini surfactants with suitably hydrophobic tails, ultra-low IFT values were measured at low surfactant concentrations. Gemini surfactants with less hydrophobic tails did not show ultra-low interfacial tensions under a wide range of temperature and salinity conditions and are, therefore, not suitable for EOR applications. The synthesized Gemini surfactants also showed lower maximum adsorption densities than the conventional single chain surfactants. The results showed the potential of utilizing these surfactants at low concentrations and in harsh reservoir conditions.

The molecular structure of the novel family of surfactants of the present invention is fundamentally different from ones that are traditionally used in EOR applications. The unique and versatile structure of these surfactants has endowed them with some fascinating properties. Their primary advantages of the surfactants over currently used EOR surfactants are: (i) they are much more salt-tolerant. They can be used in reservoirs with salinities up to 250,000 ppm and hardness ion concentrations up to 50,000 ppm, (ii) they are very surface active. Ultra-low interfacial tensions can be obtained with surfactant concentrations 10 to 100 times lower than traditional EOR surfactants, (iii) under certain conditions they form viscous solutions so that they can potentially be used without polymers, and (iv) they can be used in conjunction with traditional EOR surfactants at significantly lower concentrations than are currently needed.

The present invention also addresses the problem of oil recoveries associated in reservoirs with brines salinities in excess of 100,000 ppm, which are generally considered to be difficult targets for EOR. The novel class of surfactant molecules of the present invention, works well in such hostile environments and may make it possible to tackle this problem at a modest cost.

This present invention enables the concentration of the surfactant used in chemical EOR to be decreased by an order of magnitude. It also enables chemical EOR to be applied to difficult reservoirs with saline, hard formation brines, which are often very troublesome to design and work with for more conventional formulations. The present invention can also be a viscosifier for special rheology control in either EOR or fracturing fluid applications and a co-surfactant/co-solvent in traditional chemical EOR surfactant formulations.

The following definitions of terms apply throughout the specification and claims.

For methods of treating a hydrocarbon-bearing formation and/or a well bore, the term “treating” includes placing a chemical (e.g., a fluorochemical, cationic polymer, or corrosion inhibitor) within a hydrocarbon-bearing formation using any suitable manner known in the art (e.g., pumping, injecting, pouring, releasing, displacing, spotting, or circulating the chemical into a well, well bore, or hydrocarbon-bearing formation).

The term “polymer” refers to a molecule having a structure that essentially includes the multiple repetitions of units derived, actually or conceptually, from molecules of low relative molecular mass. The term “polymer” includes “oligomer”.

The term “bonded” refers to having at least one of covalent bonding, hydrogen bonding, ionic bonding, Van Der Waals interactions, pi interactions, London forces, or electrostatic interactions.

The term “productivity” as applied to a well refers to the capacity of a well to produce hydrocarbons; that is, the ratio of the hydrocarbon flow rate to the pressure drop, where the pressure drop is the difference between the average reservoir pressure and the flowing bottom hole well pressure (i.e., flow per unit of driving force). The idea is to flood the entire reservoir with chemical solutions to mobilize and displace the oil to the production wells.

“Alkyl group” and the prefix “alk-” are inclusive of both straight chain and branched chain groups and of cyclic groups having up to 30 carbons (in some embodiments, up to 20, 15, 12, 10, 8, 7, 6, or 5 carbons) unless otherwise specified. Cyclic groups can be monocyclic or polycyclic and, in some embodiments, have from 3 to 10 ring carbon atoms.

“Alkylene” is the divalent form of the “alkyl” groups defined above.

“Arylalkylene” refers to an “alkylene” moiety to which an aryl group is attached.

The term “aryl” as used herein includes carbocyclic aromatic rings or ring systems, for example, having 1, 2, or 3 rings and optionally containing at least one heteroatom (e.g., O, S, or N) in the ring. Examples of aryl groups include phenyl, naphthyl, biphenyl, fluorenyl as well as furyl, thienyl, pyridyl, quinolinyl, isoquinolinyl, indolyl, isoindolyl, triazolyl, pyrrolyl, tetrazolyl, imidazolyl, pyrazolyl, oxazolyl, and thiazolyl.

“Arylene” is the divalent form of the “aryl” groups defined above.

In one embodiment of the invention, an anionic surfactant composition is described for treating a hydrocarbon-bearing formation or a reservoir, wherein the surfactant is sufficiently soluble in water, hard water, hard brine or in solutions of high salinity, can reduce interfacial tension between an aqueous phase and an oil phase to below 0.001 dynes/cm and can be injected into the hydrocarbon-bearing formation of formula (I):

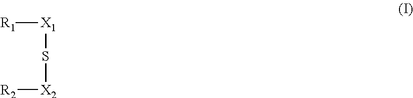

wherein R₁ and R₂ are identical or different and may independently be alkyl, alkenyl, alkynyl, alkylene, aryl, propylene oxide, ethylene oxide or hydrogen groups in a straight or branched chain with 16 or more carbon atoms, X₁ and X₂ are identical or different and are selected from the group consisting of phosphate, sulfate, carboxylate, sulfonate or other suitable anionic groups, S is a spacer group selected from short or long arkyl, alkenyl, alkynyl, alkylene, stilbene, polyethers, and other suitable aliphatic or aromatic groups comprising 2 to 12 carbon atoms. The present inventors have found that the choice of head or spacer group selected will depend on various needs and conditions, which can be optimized as described herein, for example, the head or spacer group selected can be varied based on the hydrophilic-lipophilic balance (HLB) balance of the molecule. In certain embodiments, the straight or branched chain can be C₁₆ to C₂₂, C₂₄, C₂₆, C₃₀, C₄₀, C₅₀, C₆₀, C₇₀, C₈₀, C₉₀ or even C₁₀₀. In certain embodiments, the straight or branched chain can be C₁₆, C₁₈, C₂₂, C₂₄, C₂₆, C₃₀, C₄₀, C₅₀, C₆₀, C₇₀, C₈₀, C₉₀ or even C₁₀₀.

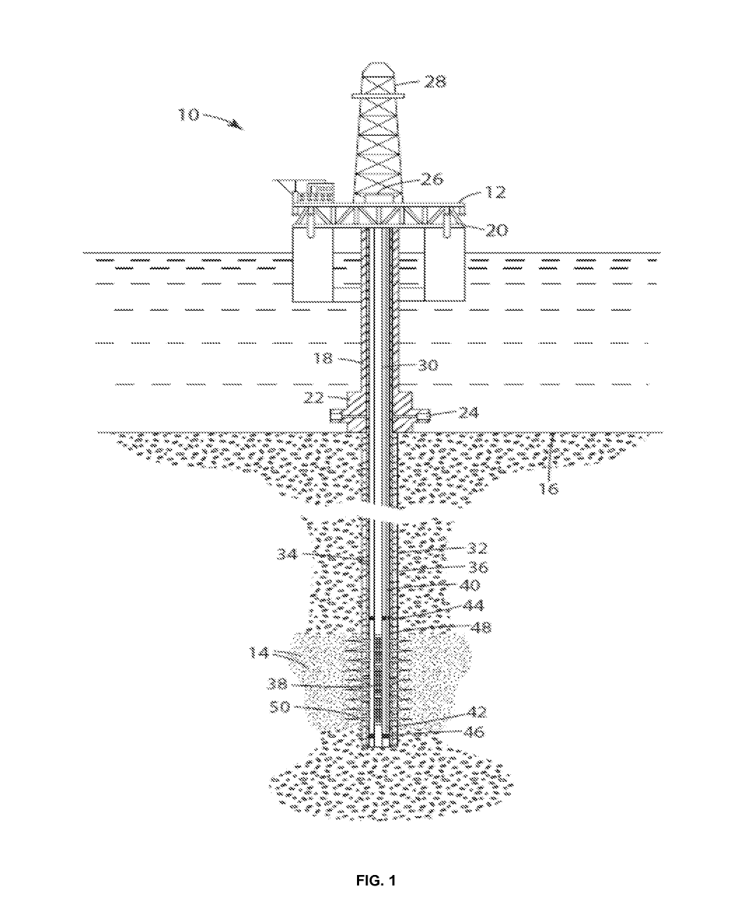

Referring to FIG. 1, an exemplary offshore oil platform is schematically illustrated and generally designated 10. Semi-submersible platform 12 is centered over submerged hydrocarbon-bearing formation 14 located below sea floor 16. Subsea conduit 18 extends from deck 20 of platform 12 to wellhead installation 22 including blowout preventers 24. Platform 12 is shown with hoisting apparatus 26 and derrick 28 for raising and lowering pipe strings such as work string 30.

Wellbore 32 extends through the various earth strata including hydrocarbon-bearing formation 14. Casing 34 is cemented within wellbore 32 by cement 36. Work string 30 may include various tools including, for example, sand control screen assembly 38, which is positioned within wellbore 32 adjacent to hydrocarbon-bearing formation 14. Also extending from platform 12 through wellbore 32 is fluid delivery tube 40 having fluid or gas discharge section 42 positioned adjacent to hydrocarbon-bearing formation 14, shown with production zone 48 between packers 44, 46. When it is desired to treat the near-wellbore region of hydrocarbon-bearing formation 14 adjacent to production zone 48, work string 30 and fluid delivery tube 40 are lowered through casing 34 until sand control screen assembly 38 and fluid discharge section 42 are positioned adjacent to the near-wellbore region of hydrocarbon-bearing formation 14 including perforations 50. Thereafter, a composition described herein is pumped down delivery tube 40 to progressively treat the near-wellbore region of hydrocarbon-bearing formation 14.

Surfactant and other chemical EOR processes aim at producing the residual oil remaining after secondary recovery with water flooding. For effective oil displacement in the reservoir rock, it is necessary to lower the interfacial tension between oil and brine to ultra-low levels (<10⁻² mN/m). Such ultra-low interfacial tension, which can be achieved with suitable surfactants adsorbing at the oil-water interface, has made it possible to conduct displacements in the field at capillary numbers several orders of magnitude greater than in waterflooding.

The use of surfactants for oil recovery has been well studied for over 80 years. Water-soluble surfactants, such as polycyclic sulfonate and wood sulfate, were described (De Groote, 1929 and 1930) as an aid to improve oil recovery in patents filed in late 1920's. Blair and Lehmann (1942) invented a well stimulation process, in which the injection of transparent emulsions was used to remove waxy solids. Holbrook (1958) suggested the use of fatty acid soaps, polyglycol ether, and salts of fatty acids for surfactant flooding, based on reduced IFT and enhanced oil recovery observed in the lab. Injected by itself, surfactant might suffer from severe retention in the reservoir. Reisberg and Doscher (1956), using a California crude and surfactant solutions containing NaOH, demonstrated in the lab that the addition of alkali produced interfacial activity related to certain components in the crude oil and that the addition of surfactant could enhance this activity. Nelson et al. (1984) proposed injection of a solution containing both surfactant and alkali for EOR. Such processes, described as alkaline surfactant processes, have attracted and continue to attract considerable interest.

The surfactants used in the 1960's (Hirasaki et al., 2011) were made either by direct sulfonation of aromatic groups in refinery streams or crude oils, or by organic synthesis of alkyl/aryl sulfonates. Throughout the 1970's and early 1980's, extensive research, field testing and implementation were triggered by an expectation of high oil prices and especially in the US, by a decline of overall oil production. Petroleum sulfonaotes (together with an alcohol cosolvent in most cases) gained popularity during this time. A series of systematic studies (Taber, 1969; Foster, 1973; Melrose, 1974; Stegemeier, 1977) led to the recognition that the capillary number controlled the amount of residual oil remaining after flooding an oil-containing core. These studies revealed that at typical reservoir fluid velocities, the crude oil-brine IFT had to be reduced from 20-30 mN/m (or dyne/cm) to values in the range of 0.001-0.01 mN/m to achieve low values of residual oil saturation. Gale and Sandvik (1973) proposed four criteria for selecting a surfactant for a tertiary oil-recovery process: i) low oil-water interfacial tension; ii) low adsorption; iii) compatibility with reservoir fluids; and iv) low cost.

Given the low oil prices from late 1980's to early 2000's, the number of chemical EOR projects saw a sharp decline. However, recent oil price developments combined with the evolution of advanced technologies and current outlook on supply/demand forecasts have resulted in a new emphasis on improving recovery factors through implementation of EOR processes, including various surfactant related processes. Researchers at, e.g., the University of Texas at Austin, have conducted extensive and productive research (Levitt et al., 2006; Jackson et al., 2006; Flaaten et al., 2007 & 2008; Zhao et al., 2008; and Zhang et al., 2008) on testing new generations of high-performance and low-cost chemical systems, and designing systematic laboratory screening protocols for testing these systems. A vast majority of these studies and those conducted in the industry have used ethoxylated and propoxylated sulfates and sulfonates. These molecules offer a rich variety of molecular structures that can be used to tailor surfactant formulations for a particular crude oil and reservoir brine.

Gemini surfactants have been used in many different applications in the past. Geminis include two covalently linked “conventional” surfactants via a spacer. The following is a schematic drawing of Gemini surfactants. Two possible joint positions: a) between polar headgroups; b) close to headgroups.

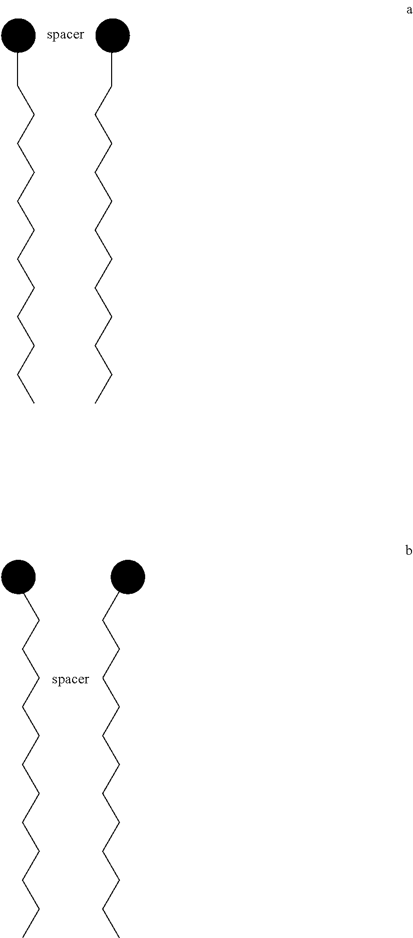

This class of surfactants can include a rich variety of anionic and cationic surfactants (Zana et al., 1993). The hydrocarbon tails can vary in length; the spacer group can be flexible or rigid, hydrophilic or hydrophobic; and the polar group can be anionic, cationic, nonionic or zwitterionic. It is this unique and versatile structure of Gemini surfactants that has recently attracted considerable interest from the academic and industrial communities (Menger et al., 1993, 2000; and Rosen et al., 1993 & 1998). Anionic Geminis, in particular, have significant water solubility, form micelles, substantially lower the surface tension, and exhibit more interesting rheological behavior compared to conventional anionic homologues (Shukla et al., 2006). The present inventors have developed a series of novel sulfate Gemini surfactants that have surprising interfacial tension, phase behavior and adsorption behaviors at surfactants at oil-water (interfacial tension) and solid-water (static adsorption loss) interfaces.

Most Gemini surfactants display ultralow critical micelle concentrations (CMC). Some of them, but not all, show ultra-high interfacial activity (e.g. in reducing oil-water interfacial tension) compared to conventional surfactants. Despite the fact that these Gemini surfactants have been identified as potential candidates for EOR applications, research into the application of specific types of Gemini surfactants specially suited for applications in enhanced oil recovery related areas is very limited.

The present invention explores the application of these Gemini surfactants in different oil and gas related operations, especially in chemical EOR operations. More specifically the present invention describes: (i) identification and testing of specific Gemini surfactant structures that yield properties that make them suitable for application in EOR applications; (ii) testing the EOR potential of Gemini surfactants using a systematic laboratory approach, including phase behavior tests, aqueous stability tests, IFT measurements and coreflooding; (iii) understanding the complex rheological behavior of Gemini aqueous solutions and to examine the feasibility of applications in mobility control and VES (viscoelastic surfactant) fracturing fluids; and (iv) studying the synergy between Gemini and conventional surfactants.

It is worth emphasizing that not all anionic Gemini surfactants are suitable for EOR applications. Typically, these molecules tend to be too water soluble to be effective (increased water solubility leads to greater partitioning into the aqueous phase, lowering the ability of the surfactants to act at the oil/water interface). Gemini surfactants that have the proper hydrophilic-lipophilic balance (HLB) are desirable. This balance depends on 1) molecular structure of the surfactants, e.g. alkyl chain length, spacer type and structure, as well as ionic head group characteristics; 2) specific conditions of the hydrocarbon formation or the reservoir, e.g. salinity and temperature. The present invention clearly shows how a structure of an anionic Gemini surfactant can be tailored to achieve the appropriate HLB under a given set of conditions.

The inventors conducted comprehensive tests to examine Geminis' ability to mobilize hydrocarbons (pure oils and crude oils) under various conditions. Elongated surfactant aggregates showed exciting rheological behavior (increased viscosity and induced viscoelasticity). For Gemini surfactants with a short spacer, the ability to form these aggregates is greatly enhanced and the concentration required is an order of magnitude lower than their conventional counterparts. Systematic measurements have been made for different surfactant concentrations, salinity and temperature conditions using a state of the art rheometer (ARES LS-1 from TA Instruments). The transport behavior of these viscosified Gemini solutions has been studied using coreflooding tests with the main objective to identify the candidate molecule and its range of working conditions for possible mobility control and fracturing applications.

In practice surfactants are sometimes used as mixtures, taking advantage of the synergy between dissimilar molecules. Study results presented in this invention show that Gemini surfactants show strong synergistic effects when mixed with high performance single-tail surfactants (FIGS. 12 and 13). The mixture shows much higher surface activity than mixtures of traditional EOR surfactants. The present inventors do not know of any past studies that have shown this synergistic effect with Gemini surfactants. Therefore, Gemini surfactants can be mixed with single-tail surfactants as co-surfactants or co-solvents for EOR applications. We show that these mixtures have better surface activity (FIGS. 12 and 13) and may also have better solubility in aqueous solutions.

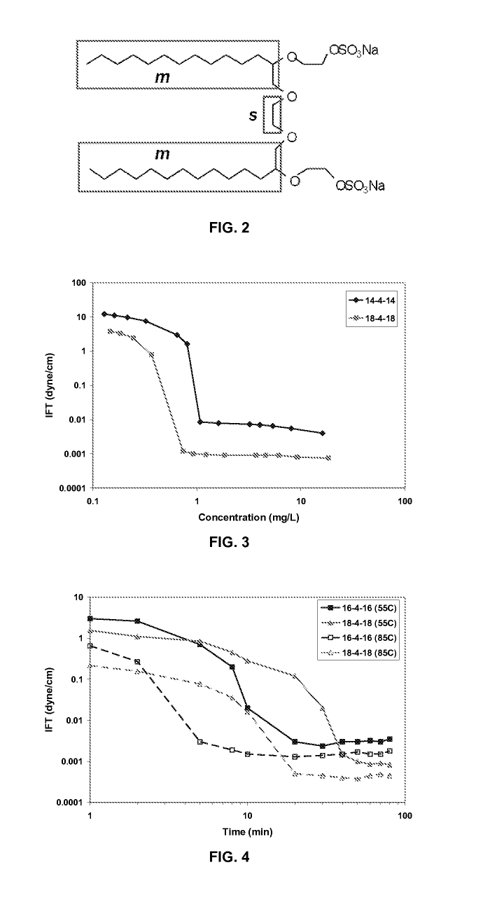

Gemini surfactants investigated in this study were synthesized using a two-step reaction scheme (Gao, 2012) adopted from reported procedures (Rist et al., 1999; Tan et al., 2006). The chemical structure of the Gemini surfactants is illustrated in FIG. 2. A popular notation m-s-m is employed here for consistency with Gemini literature, where m and s represent the number of carbon atoms in the tail and spacer groups for the molecule, respectively. The purification of the crude Gemini surfactants is essential in studies of adsorption behavior at interfaces (Gao, 2012). Gemini surfactant solutions are prepared by weighing the surfactant in distilled water and stirring using a magnetic stirrer at the desired experimental temperature.

The oil phase used in interfacial tension measurements were pure hydrocarbons purchased from Sigma-Aldrich, along with sodium hexadecyl sulfate (SHS). Some commercial surfactants used in the adsorption tests, including TDA-9PO-Sulfate, C15-18 BABS (branched alkylbenzene sulfonate) and C16-18 BABS, were samples sent from Stepan Company. The salts used to make the brine (e.g. NaCl, CaCl2) were obtained from Fisher Chemical and used as received.

Methods. Interfacial Tension Measurements. The interfacial tensions between pure hydrocarbon and Gemini surfactant solutions were measured by the spinning drop tensiometer of Model 500 (Cayias et al., 1975). The spinning drop method is based on a balance of centrifugal and interfacial tension forces. It has a wide range of measurement, 10⁻⁵˜10² dynes/cm. An outstanding advantage of the method is that an interface can be studied which is not in direct contact with any solid surface. As will be seen later, a reasonable test of equilibrium is the agreement (or otherwise) between tensions from phases that have been contacted prior to measurement and those obtained from system not originally at equilibrium.

Phase Behavior Experiments. Phase behavior experiments were conducted to study the behavior of mixtures of the hydrocarbon, brine and surfactant system at a desired temperature. Phase behavior tests were conducted following the experimental protocols recently developed at the University of Texas at Austin (Jackson, 2006; Levitt, 2006; Flaaten, 2007). Phase behavior tests include careful observations of the aqueous mixtures with the hydrocarbon phase over a sufficiently long time for them to reach equilibrium. For conventional surfactant systems, a low viscosity microemulsion will form within a few days and exhibit ultra-low IFT with both the hydrocarbon and water phases. A formulation can then be evaluated in core floods or imbibition tests depending on the application. In the current study, experiments were carried out to see if Gemini surfactants exhibit similar phase behavior to conventional single chain molecules. It should be noted that the formation of a large middle-phase microemulsion phase is not a prerequisite for the use of a surfactant for EOR applications. The formation of a microemulsion indicates that oil solubilization (into the microemulsion phase) is a likely mechanism for oil recovery. In fact the formation of a microemulsion phase may reduce oil recovery by trapping of the microemulsion phase in the rock and causing a large uptake of surfactant in the microemulsion phase making it unavailable for its main purpose—lowering the interfacial tension between the oil and water.

Static Adsorption Tests. A static adsorption test was used for measuring surfactant adsorption at solid-water interfaces. The procedures were adopted from the study by Hanna et al. (1977). The adsorbents used for static adsorption tests were particles disaggregated from a Berea sandstone core and sieved through a 60 mesh screen (<320 μm). The use of 60 mesh screen is based on the consideration that a wider and thus more representative range of particle sizes could be included. The adsorbent grains were heated in the oven overnight and cooled in a desiccator over Drierite™ before use. The surfactant concentration was measured by Total Organic Carbon (TOC) method, which represents the amount of total carbon in the sample. Detailed experimental procedures are described elsewhere (Gao, 2012). The amount of surfactant adsorbed was determined by measuring different concentrations in the solution before and after contact with the adsorbents,

Γ=(Cₒ−C)×V/M (1)

Where Γ (mg/g) is the surfactant adsorption density on the adsorbents; Cₒ and C (mg/L) are surfactant concentrations before and after adsorption tests; V (ml) is the volume of surfactant solution used in the test, and M (gram) is the mass of the adsorbents used in the test. A dimensionless quantity θ can be defined as follows:

θ=Γ/Γₘ (2)

Here Γₘ is the maximum or plateau adsorption density. Therefore, θ represents the fraction of surface area that is covered by surfactant.

Basic Characterization. Surfactants are useful and can be utilized only if they are sufficiently soluble in an aqueous phase. The solubility of ionic surfactants is commonly characterized by the Krafft temperature T_{K}, which is the minimum temperature at which surfactants form micelles. Anionic Gemini surfactants synthesized in the current study have Krafft temperatures lower than 20° C. (Gao, 2012). Comparably low Krafft temperatures were reported in many other studies (Zhu et al., 1990, 1991, 1992, & 1993).

The low Krafft temperatures of these surfactants can be explained by the concept of hydrophilic-lipophilic balance (HLB) (Becher, 1984). The HLB number for a surfactant is computed empirically by adding 7 to sum of the group numbers, gᵢ (Table 1): HLB=7+Σgᵢ.

TABLE 1
HLB Numbers of Functional Group (Sjoblom, 2001)

| Functional Group | gᵢ | Functional Group | gᵢ |
|---|---|---|---|
| —SO₄Na | 38.7 | —OH (free) | 1.9 |
| —COOK | 21.1 | —O— | 1.3 |
| —COONa | 19.1 | —(CH₂—CH₂—O)— | 0.33 |
| Sulfonate | ~11.0 | —CH—, —CH₂—, —CH₃, —CH═ | −0.475 |
| —COOH | 2.1 | —(CH₂—CH₂—CH₂—O)— | −0.15 |

Table 2 is a complete summary of the Krafft points and HLB values for all seven sulfate Gemini molecules, compared in parallel with three conventional sodium alkylsulfate surfactants (O'Lenick). Although bearing the same tail carbon chain and head group, the Gemini surfactants show much higher HLB values and thus correspondingly better aqueous solubility, compared to their conventional counterparts.

TABLE 2
Krafft Points, HLB, and CMC for Synthesized Gemini Surfactants

| | Krafft Point | | CMC (10⁻³ mmol/L) | | |
|---|---|---|---|---|---|
| Surfactant | (° C.) | HLB | 30° C. | 40° C. | 60° C. |
| 14-2-14 | <20 | 73.45 | 5.1 | 6 | 8 |
| 18-2-18 | <20 | 72.5 | 1.5 | 1.8 | 2.3 |
| 20⁺-2-20⁺ | <20 | 70.6 | 0.63 | 0.9 | 1.2 |
| 14-4-14 | <20 | 69.65 | 4.8 | 5.1 | 5.5 |
| 16-4-16 | <20 | 68.7 | 2.3 | 2.5 | 2.9 |
| 18-4-18 | <20 | 64.9 | 1.2 | 1.4 | 1.8 |
| 20⁺-4-20⁺ | <20 | 63.95 | 0.53 | 0.56 | 0.6 |
| C₁₂—SO4⁻ | 16* | 40 | 8230** | 8600** | 10160** |
| Na⁺ | | | | | |
| C₁₄—SO₄⁻ | 28* | 39.05 | 2080** | 2210** | 2770** |
| Na⁺ | | | | | |
| C₁₆—SO₄⁻ | 45* | 38.1 | — | 580** | — |
| Na⁺ | | | | | |

*Data from O'Lenick.
**Data from Mukerjee et al. (1971).

Table 2 also summarizes all the critical micelle concentration values for current series of Gemini surfactants at three different temperatures (Gao, 2012). CMC values for C₁₂-, C₁₄-, and C₁₆-sodium sulfates (Mukerjee et al., 1971) are also listed for comparison. It is apparent that CMC values for Gemini surfactants reported here are two to three orders of magnitude lower than those for the traditionally used sulfates and sulfonates. These ultra-low CMC values demonstrate the strong tendency of Gemini surfactants to self-aggregate and form micellar structures in aqueous solutions.

Interfacial Tension Measurements. Advances in our knowledge of the factors governing the reduction at that interface stem from the intense interest in enhanced oil recovery by use of surfactant solutions. The ‘surfactant flooding’ process aims at producing the residual oil remaining after secondary recovery with water flooding. For displacement of oil in the pores and capillaries of a petroleum reservoir rock, it would appear that it is necessary to reduce interfacial tension between the oil and the slug of surfactant-bearing water to ultra-low (<10⁻³ dyne/cm) values. Such ultra-low interfacial tension, which can be achieved with suitable surfactants adsorbing at the oil-water interface under pre-designed conditions, has made it possible to conduct displacements in the field at capillary numbers several orders of magnitude larger than those existing during water flooding.

Anionic Gemini surfactants have great potential of being applied in surfactant flooding thanks to their unique properties of ultra-low critical micelle concentration and high efficiency in reducing the surface tension compared with conventional single-chain surfactants (Gao, 2012). The interfacial tension of a surfactant system is greatly related to the adsorption of surfactant at the interface (Rosen, 2004). There are many factors that affect this adsorption process. In current study, the effects of the different variables on the interfacial tensions of Gemini surfactant/pure hydrocarbon/electrolyte system are systematically investigated.

Effect of Surfactant Concentration on Interfacial Tension. Surfactant molecules tend to accumulate at the oil-water interfaces where the hydrophilic and hydrophobic ends of the molecules can be in a minimum energy state. If the concentration of surfactants at the interface is very low, the molecules will lie flat on the surface (Aguiar et al., 2011). As their concentration increases, the surfactant molecules begin to orient themselves at the interface, forming a monolayer. This increases the surface pressure and decreases both the interfacial energy and the interfacial tension. At a solution concentration close to the critical micelle concentration (CMC), surfactant monomers in solution begin to spontaneously associate into larger aggregates (or micelles). At this point, no further adsorption at the interface will occur and, therefore, interfacial tension reaches the final plateau value.

Aqueous samples of 14-4-14 and 18-4-18 Geminis at different surfactant concentrations were prepared in a 20 wt % NaCl base solution. The interfacial tensions between these solutions and dodecane (n-C₁₂H₂₆) were measured at 55° C. The first thing worth noting here is that the solution had a very high salinity (20 wt % of NaCl). Even at this extremely high NaCl concentration, no phase separation or precipitation of any kind was observed for all the surfactant solutions prepared. All the Gemini surfactants synthesized in the current study have shown extraordinary tolerance to salinity indicating that they are very hydrophilic. The interfacial tensions (IFT) vs. Gemini surfactant concentration plots for the two molecules are shown in FIG. 3. Obviously, even at extremely low concentration level, some Gemini surfactants (such as the 18-4-18 molecule) are still capable of reducing the interfacial tension to ultralow levels (<10⁻³ dyne/cm). In all measurements that follow, a surfactant concentration of 0.02 wt % (˜200 mg/L) will be used to make sure we stay safely above CMC, and in the meantime still remain much lower than concentrations typically used in a conventional surfactant system (˜0.2 wt % to 2 wt % total surfactant concentration).

Dynamic IFT Response. Dynamic surface tension (DST) is critical in many industrial and biological processes (Chatterjee, 1998; Shahidzadeh, 2000). The dynamic progression of surface tension can be monitored by DST measurements (Rosen et al., 1996). Similarly, on generation of a new liquid-liquid interface, the equilibrium interfacial tension (IFT) is not instantly reached. For the tension to reach its equilibrium value surfactant molecules must first diffuse onto the interface, then adsorb and orient themselves in the interfacial region. In the meantime, some of the adsorbed molecules will try to get desorbed and go back to the bulk aqueous phase under the influence of thermal motions. This is, therefore, a dynamic and competing process among diffusion, adsorption and desorption. At initial time, interface density is really low and adsorption dominates, which results in steady reduction of IFT. As time goes on, more and more surfactant molecules accumulate at the interface, the adsorption rate decreases and gradually reaches equilibrium with desorption, and finally the IFT reaches plateau value.

FIG. 4 is the plot of dynamic interfacial tension against time for 0.02 wt % 16-4-16 and 18-4-18 solutions measured at temperature of 55° C. and 85° C. It can be seen here that both surfactants are very efficient in reducing the interfacial tension between oil and water. Furthermore, 16-4-16 is more efficient than 18-4-18 in terms of time spent for interfacial tension to reach equilibrium. At 55° C., for 16-4-16, it took about 10 minutes to reach equilibrium, in contrast to a much longer period of 40 minutes for 18-4-18. FIG. 4 also shows the effect of temperature on the dynamic interfacial tensions. Higher temperature apparently expedites the equilibrium process. For instance, at 85° C., it only took 15 minutes for IFT of 18-4-18 solution to stabilize. Elevated temperature affects the solubility of the surfactants, the CMC, and the adsorption kinetics of surfactant molecules, and the distribution of the surfactants between oil and water. It is crucial in all experiments to give every sample enough equilibration time to reach a true IFT plateau, and this can be accomplished by strictly following the equilibration criteria that requires three consecutive drop width readings from the tensiometer to agree to within ±0.001 cm.

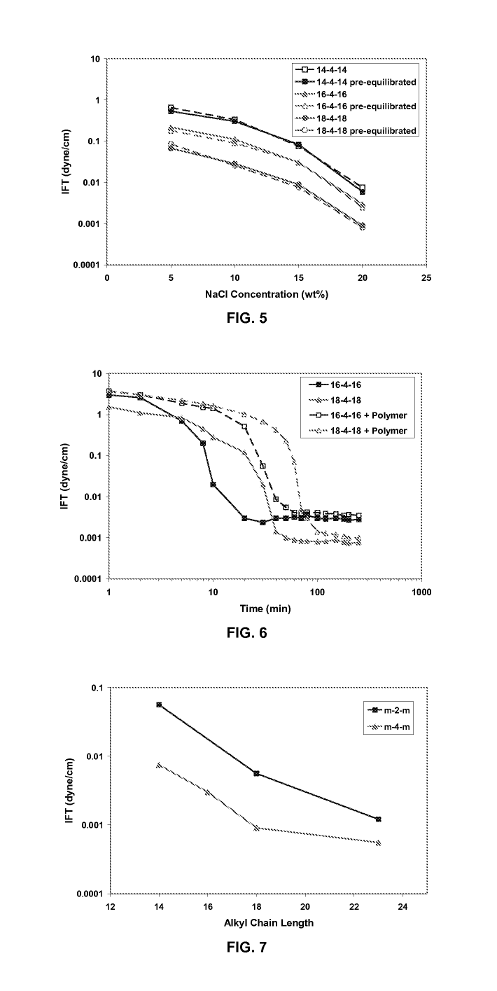

Comparison with Pre-Equilibrated System. In FIG. 5, interfacial tension is plotted against the salt concentration for systems containing a Gemini surfactant, aqueous NaCl and dodecane at 55° C. Included in the plot are values obtained in two different ways. First, results are shown for systems in which pure dodecane was introduced directly into aqueous surfactant which has not previously been equilibrated with the oil phase. Initially, a coating was observed to form around the oil drop; the coating was quite fluid and the drop shape responded rapidly to changes in rotation speed of the tensiometer capillary. Eventually, the coating became detached from the drop leaving an apparently clean oil/water interface, and the drop radius became stable; tensions recorded were those for such clean interfaces.

Equilibrium systems were prepared in which dodecane was mixed with aqueous surfactant in test vials and left in the oven at 55° C. for one week. Oil and aqueous phases on top and at bottom were taken and introduced into the tensiometer. It is apparent from FIG. 5 that the tensions so obtained were in close agreement with those for the non-equilibrated systems described above. These results give us confidence in our IFT experimental procedures, especially regarding how to obtain true equilibrated IFT values. Similar agreements between IFT values obtained from non- and pre-equilibrated systems were also reported by Aveyand and Binks (1986, 1988). They also used a surface light scattering technique to determine the tensions in equilibrated systems. All three sets of data are in exceptional agreement.

Mixing with Polymer. Surfactant-based formulations often contain water-soluble polymers that improve the properties of the formulations. Therefore, it is important to study the interaction of Gemini surfactants with water-soluble polymers. The study of interactions between surfactants and polymers is an active field of interest in colloid science. We investigated the effect of 500 ppm HPAM3330 (from SNF) addition on the dynamic interfacial tension between oil and Gemini surfactant solution. It can be seen from FIG. 6 that HPAM has a transient effect on the dynamic IFT response. It takes more time to reach the equilibrium interfacial tension with the addition of HPAM, but it has little effect on the equilibrium IFT values. This can be explained by the fact that the addition of HPAM increases the viscosity of the solution, which in turn reduces the rate of diffusion of the surfactant molecules, thereby slowing down the adsorption of the surfactant onto the interface. The results clearly indicate that while the polymer increases the time to reach the equilibrium IFT value, the reduction is equilibrium IFT is the same. This means that the particular Gemini surfactants that show ultra-low IFT values can be used for EOR applications with or without the polymer.

Alkyl Chain Length. As the alkyl chain gets longer, we see a gradual decrease in IFT in FIG. 7. Indeed, as the hydrophobe gets larger, the hydrophilic-lipophilic balance (HLB) is adjusted in such a way that the surfactant molecules become more lipophilic, and thus have higher tendency to move from the bulk aqueous phase onto the oil-water interface. Once there, they can orient themselves so that the large hydrophobes point towards the oil phase to reduce the free energy of the system. All the Gemini molecules shown in FIG. 7 have demonstrated their ability to effectively reduce oil-water IFT by several orders of magnitude (from the original ˜50 dynes/cm). Remarkably, this reduction occurs at very low surfactant concentrations (0.02 wt %) as shown by our measurements. Ultralow interfacial tensions (<10-3 dyne/cm) were, however, only observed for Geminis with longer alkyl chain and spacer group, i.e. 18-4-18 and 20+-4-20+. This is because these two molecules are better HLB balanced (more lipophilic) under this specific set of salinity (20 wt % NaCl) and temperature (55° C.) conditions.

The HLB calculation carried out earlier showed that all the Gemini surfactants synthesized are very hydrophilic. While this hydrophilicity definitely helps out in dissolving these long chain surfactant molecules into aqueous solution even at extremely high salinity, it hurts their performance in reducing IFT. In order to further reduce the IFT, the HLB balance must be adjusted for these molecules. There are a few approaches to achieve this: (1) changes in aqueous solution condition, e.g. to increase electrolyte concentration in the solution and thus push the surfactant molecules onto the oil-water interface; or raise the solution temperature and promote adsorption at the interface; (2) manipulations on the molecular structure, e.g. to make the surfactant more hydrophobic by introducing longer tail (as discussed in current section) and spacer groups, or switch to less hydrophilic head groups, such as carboxylates.

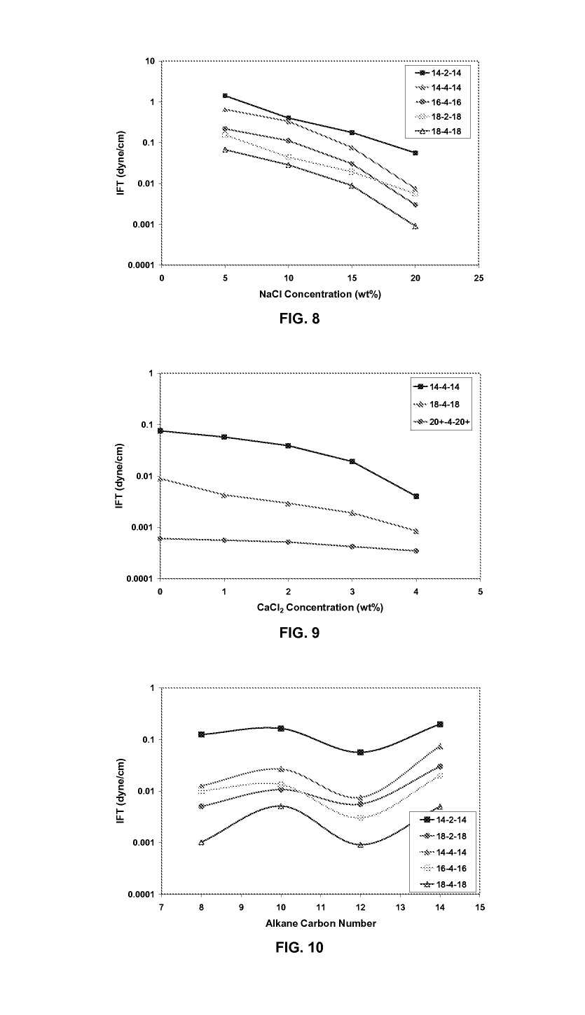

Monovalent Salt (NaCl) Concentration. The interfacial tensions were measured between hydrocarbon and Gemini solutions with various amount of NaCl added. Results in FIG. 8 show the positive impact of higher NaCl concentration on lowering the tension of an oil-water interface. The solubility of Gemini surfactants in highly saline solutions should be noted. As more NaCl is added, the interfacial tension steadily goes down. This is consistent with data for other surfactants and is to be expected. However, we did not observe any salting out of the surfactant indicating that Gemini surfactants show good salt tolerance. The increase in effectiveness of surfactant by the addition of salt is a result that has been well explained earlier through a modification of electrical double layer at the oil-water interface and the reduced hydrophilicity of the surfactant at high salinities due to ion binding at the surfactant head groups. Notice that, the lower IFT values were observed towards the higher end of the salinity range (15 to 20 wt %) for Gemini surfactants. For conventional surfactants, on the other hand, the lowest interfacial tension usually occurs over a narrow salinity window below a TDS of 100,000 ppm (10 wt %). Therefore, one potential area where Gemini surfactants can be used and may perform better would be in high temperature, high salinity environments, which are commonly encountered in the oil reservoirs around the world. It should be noted that over the wide range of salinities examined in this section, we have yet to find a minima of interfacial tension with regard to salinity.

Divalent Salt (CaCl2) Concentration. Divalent ions such as Ca2+ and Mg2+ are more efficient in driving surfactant molecules onto the oil-water interface than monovalent ions. Most conventional EOR surfactants do not work well at high concentrations of divalent ions, often showing precipitation or phase separation upon addition of Ca2+ and Mg2+ to their aqueous solutions. As shown earlier Gemini surfactant solutions can withstand high concentrations of NaCl; it is thus natural to test the aqueous stability and IFT reduction capabilities of Gemini solutions under the influence of divalent ions. A series of 0.02 wt % Gemini solutions (already containing 15 wt % NaCl) were prepared with different amounts of CaCl2 added and the IFT values were measured between these aqueous solutions and pure dodecane. The results are shown in FIG. 9. First and most importantly, no solubility problems were encountered in these tests, even when the CaCl2 concentration went as high as 4 wt %. The addition of divalent ions helps further reduce the IFT and ultralow values were observed. Formation brines with TDS (mono- and di-valent ions together) in excess of 150,000 ppm are generally considered to be difficult targets for EOR operations. Gemini surfactants are shown here to perform well (in terms of solubility and interfacial tension reduction) in such environments, which makes it possible to handle these difficult situations with simpler chemical systems.

Hydrocarbon Type. For conventional surfactants, the molecular interactions (Bourrel et al., 1983 & 1987) taking place at the oil-water interface are strongly affected by the nature of the surfactant, the characteristics of the oil and solution conditions of the aqueous phase. This is the fundamental reason why laboratory surfactant screening is always performed individually and customized to the specific oil and brine combination. FIG. 10 shows ACN (alkane carbon number) scans performed on five different Gemini surfactants, to investigate the effect of hydrocarbon type on IFT values. For conventional surfactants, there is typically an optimum ACN number corresponding to a minimum IFT value (Bourrel et al., 1987). For Gemini surfactants, the IFT results in FIG. 10 do not show a strong preference to any particular hydrocarbon (at least for the oils tested here). There is, however, a local minimum at an ACN value of 12, e.g. dodecane for all the Geminis investigated, which is the reason why dodecane is used as the oil phase in most IFT measurements reported in this chapter. The absence of an optimal ACN number can be used to our advantage in the surfactant screening process, since Gemini surfactants can potentially be used for a range of different hydrocarbons. This is particular beneficial when dealing with crude oil systems, which are typically complex combinations of hydrocarbons of various ACN values. With Gemini surfactants, there is a better chance of finding a formulation that can be used for a wider range of oils.

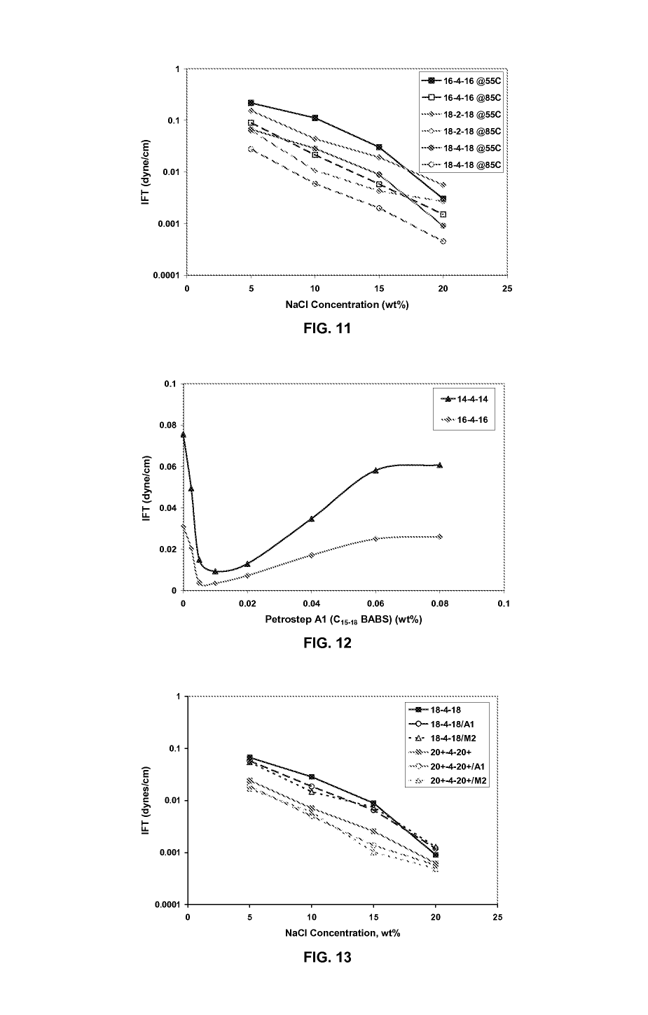

Temperature. Temperature affects solubilities and interaction energies of hydrophobes and head groups in aqueous solution. As shown in FIG. 11 higher temperature promotes adsorption of Gemini molecules onto the water-oil interface resulting in lower values of the interfacial free energy or interfacial tension.

Synergy with Conventional Surfactants. In many practical applications, different types of surfactants are deliberately mixed together to improve the properties of the final product. In such cases, what is sought is a synergy between the surfactants. The goal is to obtain properties of the mixture that are better than those attainable with the individual components by themselves. For example, a nonionic surfactant is often added to a phase behavior formulation based upon an anionic surfactant because the overall performance (aqueous stability and phase behavior) of the mixture is better than that of either surfactant by itself. It is evident to us that, in the future, the more hydrophilic Gemini surfactants will most likely be used in mixtures with conventional surfactants for both cost and performance considerations. The properties of such mixtures must, therefore, be investigated in order to better understand mixture behavior and properties.

In the current study we investigate the synergy between Geminis and conventional surfactants in terms of IFT reduction. The conventional surfactants studied here are branched alkyl benzene sulfonates (BABS), i.e., Petrostep A1 (C15-18 BABS) and Petrostep M2 (C16-18 BABS). These surfactants are chosen because of their hydrophobic nature. The expectation was that the strong hydrophilicity of Gemini surfactants might compensate for the relative lipophilicity of the other surfactant molecules. FIG. 12 shows a concentration scan of Petrostep A1, conducted at 55° C. and in aqueous solutions containing 0.02 wt % Gemini and 15 wt % NaCl. With only about 0.01 wt % of Petrostep A1 added, the interfacial tensions between aqueous solutions and dodecane were reduced to ultralow levels (<10-3 dyne/cm). Two aspects are worth noting here: (i) the hydrophobic ABS type surfactant is stable and remains dissolved in an aqueous solution that contains 15 wt % NaCl, due to the existence of hydrophilic Geminis in solution; (ii) the interfacial tension from the surfactant mixture reaches ultralow levels, which is not achievable by the individual surfactant components. The molecular interaction between the Gemini and conventional surfactants provide mutual benefits that contribute to aqueous stability and interfacial activity. This leads to a new possibility of making use of Gemini surfactants. They can be used as co-solvents that help the solubility of the main surfactants, or as co-surfactants that help bring out the best performance of the surfactant mixture. FIG. 13 shows the salinity scan results using surfactant mixtures with fixed composition. Lower interfacial tensions were observed after the ABS surfactant was added into Gemini surfactant solutions, but only to a limited extent in some cases. The optimal concentration ratio between Gemini and conventional surfactants will depend on the specific structure of the molecules involved and solution conditions they are subject to. Nevertheless, all the surfactant mixtures are readily soluble in saline solutions, showing again the improved solubility that Gemini surfactants are able to bring to the mixture.

Phase Behavior Studies. Surfactant formulations for EOR applications are commonly selected on the basis of phase behavior experiments (by evaluating the microemulsion created with hydrocarbon, water, and surfactant mixtures). In the current study, experiments were carried out to see if Gemini surfactants exhibit similar phase behavior to conventional single chain molecules. Table 3 summarizes the experimental conditions examined in the phase behavior tests.

TABLE 3
Experimental Conditions Examined in Phase Behavior Test

| | Surfactant | | | |
|---|---|---|---|---|
| | Concentration | Temperature | | |
| | (wt %) | (° C.) | Salinity Scan | Oil Scan |
| Group I | 0.01, 0.02, | 45, 55, 85 | up to 20 wt % | C8, C10, |
| Salinity | 0.1, 0.2 | | NaCl | C12, C14 |
| Group II | 0.01, 0.02, | 45, 55, 85 | 15 wt % NaCl + | C8, C10, |
| Hardness | 0.1, 0.2 | | up to 5 wt % | C12, C14 |
| | | | CaCl₂ | |

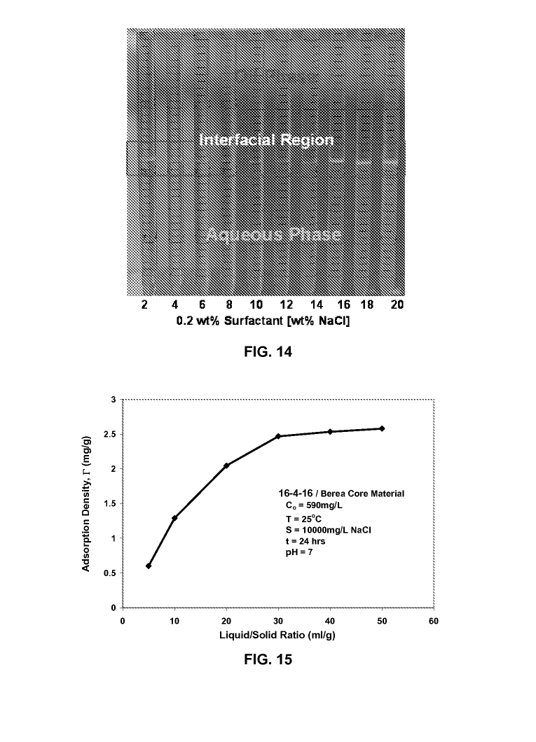

FIG. 14 shows the phase behavior pipettes prepared for 0.2 wt % 16-4-16 Gemini surfactant. These pipettes actually present very well what we generally observe in phase behavior tests for Gemini surfactants under different conditions. A first common observation made is that even with salinity as high as 20 wt %, no phase separation or precipitation take place, showing the superb salinity (and/or hardness) tolerance of this molecule. Another common observation across different conditions tested is the absence of a significant Type III middle phase. In fact, most test pipettes showed a Type I appearance even after an extended period of equilibration. On the other hand, ultra-low interfacial tensions (ULIFT) were indeed measured under the same conditions as the phase behavior tests. At first, this appears to be contradictory to the “common notion” that ultra-low interfacial tension and Type III microemulsion phase always go together. Fundamentally, however, IFT reduction and oil solubilization (Type III middle phase formation) are two separate phenomena, controlled by different processes.

The interfacial tension of a surfactant system is related to the adsorption of surfactant molecules at the interface. The fact that Gemini surfactants can pack more closely at the interface helps the system to reach ULIFT despite a low solubilization ratio. On the other hand, conventional surfactants cannot form an interfacial packing as compact as Geminis. The closer packing by Gemini molecules can be ascribed to at least two facts: i) intramolecular level: the existence of the short spacer group chemically constrains the distance between the two tails; ii) intermolecular level: the extremely high salinity conditions that Gemini surfactants can withstand helps screen out the electrostatic repulsion between headgroups and thus facilitates even closer packing.

The oil solubilization capability of a surfactant is controlled by the overall free energy of the hydrocarbon/surfactant (co-surfactant)/electrolyte system (Nagarajan et al., 1991; Moreira et al., 2010). For conventional surfactants at sufficient concentration, the minimization of free energy requires that the oil molecules be incorporated with the surfactant molecules to form swollen micelles or even bicontinuous (middle phase) structures. Whereas for Gemini surfactants, due to their high tendency to self-aggregate, especially at higher concentration and with salt addition (Gao, 2012), it is possible that the free energy (or IFT) can be minimized when the Gemini molecules self-assemble by themselves, without solubilizing a significant amount of oil molecules. This may be a potential advantage in EOR applications for reasons stated earlier.

Although Type III systems are not generally observed in phase behavior experiments for Gemini surfactants with sulfate head groups, the success of applying Geminis in chemical EOR is still promising. Firstly, salinity and/or hardness tolerance is very important for applications in harsh reservoir conditions. Moreover, for conventional surfactant systems, low IFT can only be obtained in the Type III microemulsion window, in which case oil can be solubilized into a microemulsion phase. However, for Gemini surfactants, the ULIFT may be achieved without the formation of a microemulsion phase. Surfactant flooding under Type I phase behavior conditions but with ULIFT (Austad et al., 2000) may have an advantage over a conventional (Type III) process since complicated phase behavior in the reservoir can be avoided and microemulsion trapping will no longer be an issue. Finally, there are other possible ways of optimizing the HLB of the surfactant molecules such as the use of carboxylate headgroups which will result in Gemini surfactants that are less hydrophilic and, therefore, show better phase behavior.

Static Absorption Tests. Loss of surfactant due to its interaction with reservoir rocks is always a key concern for economic reasons, especially when we consider the use of a low concentration Gemini surfactant slug in a flooding process. The equilibrium adsorption of surfactants at the solid-water interface depends on the nature of the surfactants and the absorbents (Paria and Khilar, 2004). The behavior of surfactants at solid-water interfaces is determined by a number of forces, including electrostatic attraction, covalent bonding, hydrogen bonding, and hydrophobic bonding, etc. (Somasundaran and Huang, 2000). Sands and sandstones typically have a specific surface area of 1 to 10 m2/g, and the clay content is responsible for most of that surface area. The disaggregation of any rock or mineral sample will typically result in material of higher surface area, and higher surface energy. As a result, the static adsorption tests often give higher values for adsorption than those observed in consolidated sandstones containing these materials (Jordan et al., 1995). However, the important sensitivities to parameters like salinity and temperature may still be in the correct direction for predicting and analyzing consolidated core flooding experiments in reservoir cores.

The adsorption behavior of anionic Geminis applied to EOR has not been investigated in the past. Mannhardt et al. (1992) carried out adsorption studies with several form-forming surfactants on core samples of Berea sandstone. One surfactant blend investigated in their paper contained a DOWFAX® 3B2, a mixture of monoalkyl disulfonate and dialkyl disulfonate. Their results showed that the blend gave the lowest adsorption onto sandstone, and that the trends in adsorption can be explained on the basis of the interaction of the charge on the surfactant with the solid surface changes. In this section, the adsorption data of synthesized anionic Gemini surfactants onto Berea core materials are determined by static adsorption tests and compared with similar tests conducted with conventional EOR surfactants. The effects of different variables are systematically studied.

Equilibrium Adsorption Conditions. Liquid/Solid Ratio (LSR). Adsorption results obtained for a 16-4-16 disulfate Gemini molecule on Berea core material (sieved through 60 mesh screen) at different liquid/solid ratios (LSR) are shown in FIG. 15. All surfactant solutions were prepared in 10,000 mg/L NaCl brine, with a constant concentration of 590 mg/L. To ensure equilibration, the liquid-solid mixtures were agitated for 24 hours at 25° C. As shown in FIG. 15, the amount of surfactant adsorbed starts to stabilize (or saturate) at LSR of 30, with a value of 2.467 mg/g. The adsorption curve flattens out beyond this value. Ideally, for a well-defined system under equilibrium conditions there should be no effect of liquid/solid ratio (LSR) on adsorption results. Therefore, a LSR value of 40 was selected in all the tests.

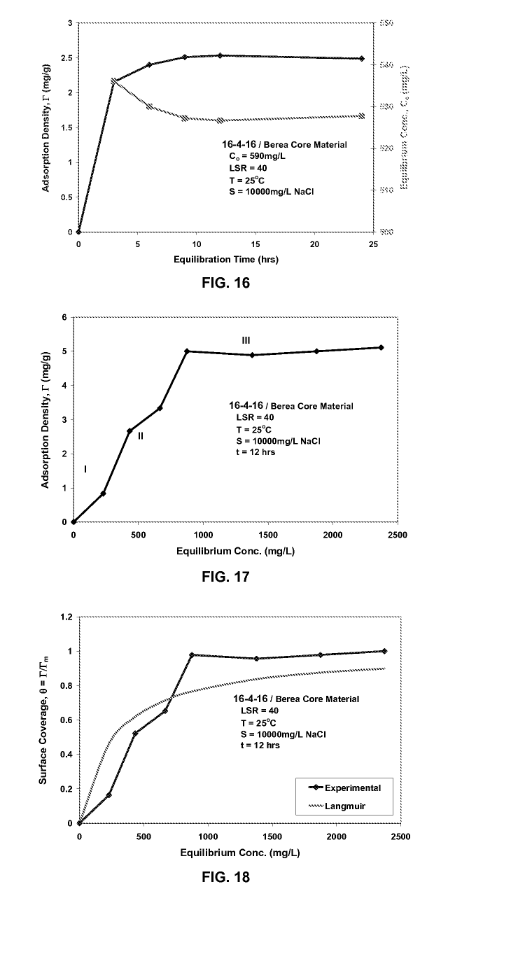

Equilibrium Adsorption Time. To ensure true equilibrium adsorption, the progression of 16-4-16 adsorption level with time was recorded to identify a suitable duration for equilibration. Once again the aqueous solutions were prepared in 10000 mg/L NaCl brine, with a constant surfactant concentration of 590 mg/L. The liquid-solid mixtures at LSR of 40 were agitated at 25° C. for different durations. The results are shown in FIG. 16. As can be seen in the figure, with 12 hours of agitation, the adsorption level reaches 2.533 mg/g and does not change significantly with time afterwards. Therefore, an equilibrium adsorption time of 12 hours was chosen for all the adsorption tests in the current study. Also shown in the plot is the equilibrium surfactant concentration measured from the supernatant liquid by TOC. After 12 hours of equilibration, C also reaches a minimum that corresponds to the maximum adsorption density.

Adsorption Behavior of 16-4-16. Adsorption Isotherm. With equilibrium experimental conditions identified, we measured the adsorption isotherm for 16-4-16 Gemini surfactant by progressively changing the initial surfactant concentration in the static test, and calculating the amount of surfactants adsorbed per gram of solid. The surfactant solutions were all prepared in the presence of 10,000 mg/L NaCl. The liquid-solid mixtures at 40 LSR were agitated for 12 hours before TOC analysis. The isotherm is shown in FIG. 17. Most adsorption studies have employed a similar method with the results being presented as isotherms which are plots of the amount of surfactant adsorbed per gram of solid versus the equilibrium surfactant concentration at a constant temperature. These plots can be used to obtain information over a wide range of surfactant concentrations, and they generally have four regions with noticeable slope changes as surfactant concentration increases (Paria and Khilar, 2004).

As shown in FIG. 17, the adsorption process of 16-4-16 can be roughly divided into three regions. At low surfactant concentrations, designated as region I, the surfactant monomers get adsorbed as individual ions with no interactions between the adsorbed molecules (Bohmer et al., 1992). The adsorption is due to electrostatic interaction between the head groups and charged sites on the solid surface. This attraction obeys Henry's law and adsorption increases linearly with concentration (Paria and Khilar, 2004). The much faster increase of adsorption in region II was due to the association of the adsorbed surfactants at the solid-water interface (Wesson et al., 2000). These associations were attributed to lateral hydrophobic interactions between surfactant tails. This lateral attraction generates an additional driving force, and with the still existing electrostatic attraction, makes the adsorption isotherm curve in this stage exhibit a sharp increase. Adsorption of surfactant is proposed to occur with a reduced slope after region II, often referred to as region III (Paria and Khilar, 2004). Region III can be attributed to the surfactant ions having filled all of the surface sites by the end of region II with further adsorption being due to association between first and second layer hydrocarbon chain. Scamehorn et al. (1982) proposed that bilayer formation began in region II and continued into region III. This type of behavior is, however, not observed in FIG. 17. The exact shape of the isotherm will depend on many different factors that could be unique in each adsorption test. Finally, a plateau of the adsorption isotherm, shown as region III, is characterized by little or no increase in adsorption with increasing surfactant concentration. In this region micelles start to form in bulk solution and act as a chemical potential sink for any additional surfactant added into the system. The adsorption isotherm is re-plotted in FIG. 18 by employing the dimensionless quantity 0 (surface coverage) defined previously. A best fit of the Langmuir adsorption equation to the experimental data is also shown in the figure, with a R2 value of 0.8354. Comparing the two curves, the Langmuir model is capable of capturing the general trend of the adsorption behavior of 16-4-16 onto Berea core material.

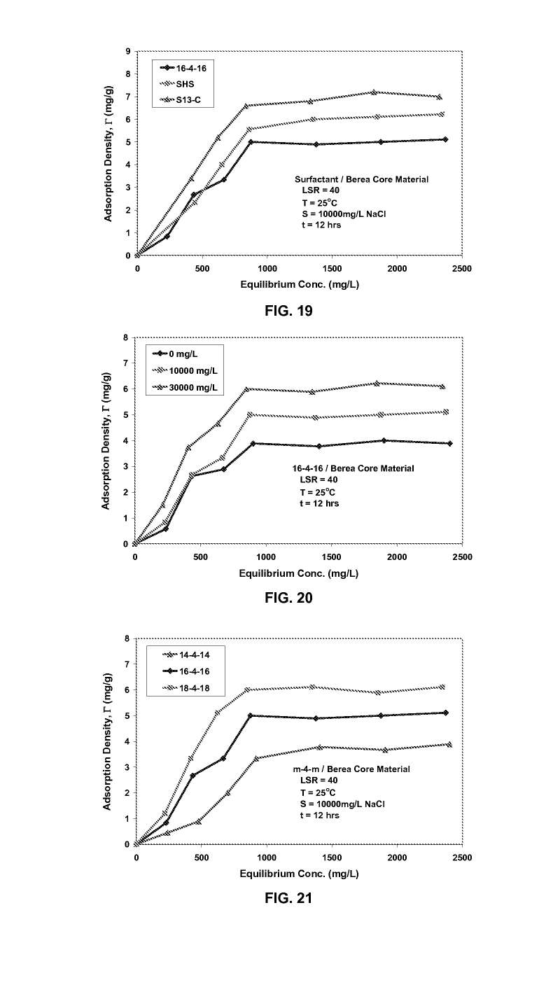

Comparison with Conventional Surfactants. With all study conditions kept the same (10,000 mg/L NaCl, LSR of 40, 12 hrs. equilibration at 25° C.), we compare the adsorption behavior of 16-4-16 Gemini with its single-chain counterpart SHS (sodium hexadecyl sulfate), as well as a commercial surfactant Petrostep S13-C (TDA-9PO-Sulfate). It can be seen from FIG. 19 that maximum adsorption densities of the three surfactants follow the trend of 16-4-16<SHS<S13-C. Possible explanations to the low adsorption of 16-4-16 include the hydrophilicity and the dual-head-group structure of Gemini surfactants.

First of all, Gemini surfactants are much more hydrophilic than their conventional counterparts. Therefore, they will have a higher tendency to go into the bulk aqueous phase than conventional surfactants, which makes it harder for Geminis to get adsorbed at the solid surface. Secondly, the two sulfate head groups in one molecule makes a Gemini effectively a bi-functional ion. Therefore one Gemini molecule can potentially interact with more than two adsorption sites on the solid surface, and thus saturate the adsorption sites more efficiently. Oida et al. (2003) proposed that the bulkier structure of a Gemini surfactant, especially towards the head group end, could give rise to difficulty packing the surfactant molecules at the interface, which in effect reduces adsorption tendency. However, based on our results from surface tension experiments (Gao, 2012), Gemini surfactants are actually capable of packing together more tightly than conventional surfactants, at least at the air-water interface. Considering, however, the difference between the adsorption conditions at solid-water interface and air-water interface, Oida's proposal could be true here as well. By the same argument, S13-C, being the most hydrophobic molecule among the three, has a higher tendency to get adsorbed at the solid-water interface, resulting in the highest adsorption density. Moreover, SHS and S13-C are both mono-functional surfactants. Assuming similar adsorption sites were provided in their respective test, the amount of surfactants adsorbed might be comparable at least on a molar basis. With S13-C being a higher MW molecule, it is not surprising to see a higher adsorption of S13-C (on a mass basis) in FIG. 19.

Effect of Salinity. It was clearly shown in previous sections that the formation of surface aggregates has an important impact on the adsorption density of surfactants on a solid-water interface. Therefore, any factor that might affect the aggregation behavior is likely to cause changes in the adsorption behavior. Solution salinity is one such parameter. Three surfactant solutions of different salinities were prepared and mixed with the adsorbents. All other experimental conditions were kept the same. FIG. 20 shows a comparison between the three cases. The adsorption density increases with solution salinity. This trend agrees with our intuition and can be explained at least three ways: i) the existence of larger amount of sodium ions at higher salinities will significantly suppress the electrostatic interaction (repulsion) between the surfactant head group and the double layer on the solid surface; ii) the addition of salt can promote the growth of various surface aggregates, into which more surfactant molecules will be incorporated; iii) higher salinity will also reduce the solubility (Somasundaran et al., 1998) of the surfactants in aqueous phase and thus push them towards the solid-water interface.

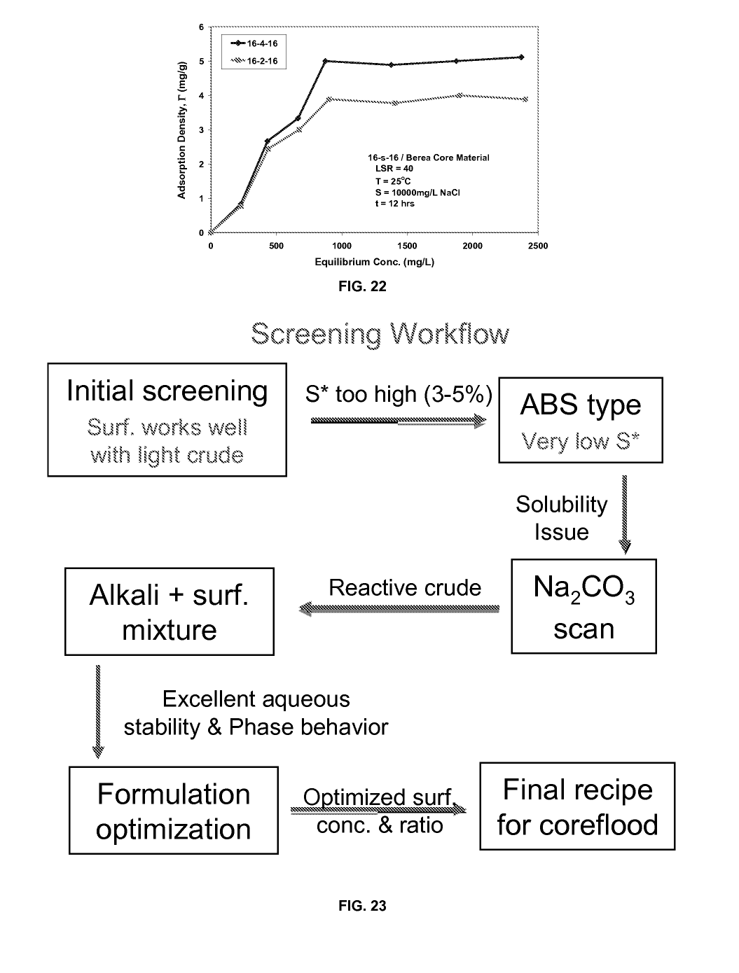

Impact of Molecular Structure. An increase in the length of the non-polar part of a surfactant generally causes an increase in adsorption owing to increased lateral interactions between hydrocarbon chains. Results in FIG. 21 for three Gemini surfactants of different tail lengths clearly indicate an increase in adsorption with an increase in chain length. Similar behavior (Esumi et al., 1996; Li et al., 2000; Rosen et al., 2001) has been observed for many other surfactants (conventional and cationic Gemini) systems for the same reason. Longer hydrocarbon tails also reduce the solubility of the Gemini molecule in bulk aqueous phase and thus tend to increase adsorption onto the solid-water interface. FIG. 22 shows the effect of spacer group length on the adsorption behavior of Gemini surfactants. As can be seen here, the molecule with a shorter spacer has a smaller plateau adsorption density for basically the same reason mentioned above, namely, stronger intermolecular interactions and reduced solubility.

A systematic laboratory testing program was conducted on the oil-water and solid-water interfacial properties for a new family of anionic surfactants that has great potential for EOR applications. A series of anionic surfactants with different length of hydrophobic tail and linking spacer group were synthesized and their interfacial properties and adsorption behavior studied. These molecules showed excellent aqueous stability even in high salinity and hard brines. Ultra-low IFT values were measured at very low surfactant concentrations. The synthesized Gemini surfactants also showed lower maximum adsorption densities than the conventional single chain surfactants. The results from this study showed the potential of utilizing these surfactants at low concentrations and in harsh reservoir conditions (high temperature and salinity) for EOR applications. The following specific conclusions can be made from current study:

The anionic Gemini surfactants, synthesized in this study, show extraordinary tolerance to salinity and/or hardness. Even with extremely high concentrations of NaCl (up to 20 wt %) and/or CaCl₂ (up to 5 wt %) present in solution, no phase separation or precipitation of any kind was observed for all the samples prepared. Ultra-low IFT values were observed towards the higher end of the salinity and/or hardness range for Gemini surfactants. Gemini surfactants can thus be potentially used at very high temperatures and salinities, which are commonly encountered in oil reservoirs around the world.

The molecular interaction between Gemini and conventional surfactants provide mutual benefits that contribute to aqueous stability and interfacial activity. This leads to a new possibility of making use of Gemini surfactants as co-solvents that help the solubility of the main surfactants, or as co-surfactants that help improve the performance of the surfactant mixture. It was clearly shown that not all Gemini surfactants are suitable for EOR applications. The HLB balance could be further adjusted through modifications to the tail length and changes in the head group for better performance.

A series of static adsorption tests were conducted to study the adsorption behavior of Gemini surfactants onto a solid-water interface. By utilizing disaggregated and screened Berea core material as adsorbents, an adsorption plateau can be reached at a liquid-solid ratio of 40 (ml/g) and equilibration time of 12 hours. The Langmuir adsorption model is capable of capturing the general trend of the adsorption behavior of Gemini surfactant onto the adsorbents.

Gemini surfactant shows lower plateau adsorption density than conventional EOR surfactants. Lower adsorption can be achieved by decreasing the solution salinity, based on the considerations of prohibiting surface aggregate growth and promoting electrostatic repulsion. Longer alkyl chain and spacer group promote surfactant adsorption due to reduced solubility and stronger interactions with the solid surface.

The unique and versatile structure of the anionic surfactants of the present invention, namely ultralow critical micelle concentrations (CMC), very high surface activities, novel rheological properties and extreme water solubility and hard-water tolerance make them very attractive candidates for EOR applications particularly in difficult reservoirs with saline, hard formation brines thus significantly broadening the application scope for conventional chemical EOR methods. It is contemplated that any embodiment discussed in this specification can be implemented with respect to any method, kit, reagent, or composition of the invention, and vice versa. Furthermore, compositions of the invention can be used to achieve methods of the invention.

FIG. 23 is a flowchart that was used to identify, in one example, the optimal chemical system subject to reservoir conditions. In the first step 100, an initial screening is conducted in which the surfactant is tested to determine if it works well with, e.g., light crude. If the surfactant is too high (3 to 5%, then in step 102 the ABS type is determined, such as a very los surfactant. To work on the solubility issue, then in step 104 a Na₂CO₃ scan is conducted and reactive crude is determined. In step 106, an alkali and surfactant mixture is evaluated and a combination of aqueous stability and phase behavior is determined. In step 108, the formulation is optimized for both surface concentration and ratio. Finally, in step 110, the final recipe is decided upon for use with core flooding.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

What is claimed is:

1. An anionic surfactant composition for treating a hydrocarbon-bearing formation or a reservoir, wherein the surfactant is sufficiently soluble in water, hard water, hard brine or in solutions of high salinity, can reduce interfacial tension between an aqueous phase and an oil phase to below 0.001 dynes/cm and can be injected into the hydrocarbon-bearing formation of formula (I): 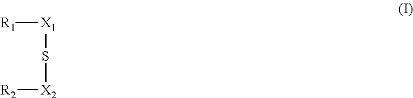
wherein R₁ and R₂ are identical or different and may independently be alkyl, alkenyl, alkynyl, alkylene, aryl, propylene oxide, ethylene oxide or hydrogen groups in a straight or branched chain with 16 or more carbon atoms, X₁ and X₂ are identical or different and are selected from the group consisting of phosphate, sulfate, carboxylate, sulfonate or other suitable anionic groups, S is a spacer group selected from short or long arkyl, alkenyl, alkynyl, alkylene, stilbene, polyethers, and other suitable aliphatic or aromatic groups comprising 2 to 12 carbon atoms.

2. The composition of claim 1, wherein the composition is used alone, in conjunction with a polymer, with another surfactant, or as part of an alkaline surfactant polymer (ASP) composition for treating the hydrocarbon-bearing formation.

3. The composition of claim 1, wherein the composition is used for enhanced oil recovery (EOR), environmental ground water cleanup, and other surfactant based applications.

4. The composition of claim 1, wherein the composition is used to treat the reservoir with salinities of up to about 350,000 ppm.

5. The composition of claim 1, wherein the composition is used to treat the reservoir with salinities of 200 ppm, 500 ppm, 1000 ppm, 5000 ppm, 10,000 ppm, 50,000 ppm, 100,000 ppm, 150,000 ppm, 250,000 ppm, 350,000 ppm.

6. The composition of claim 1, wherein the composition is used to treat the reservoir with a hardness ion concentration of up to about 50,000 ppm.

7. The composition of claim 1, wherein the composition is used to treat the reservoir with a hardness ion concentration of 200 ppm, 500 ppm, 1000 ppm, 5000 ppm, 10,000 ppm, 50,000 ppm.

8. The composition of claim 1, wherein the composition is thermally stable at temperatures of 200° C. or greater.

9. The composition of claim 1, wherein the composition is thermally stable at temperatures of 50° C., 100° C., 150° C., 200° C.

10. The composition of claim 1, wherein the composition has a formula (n-C₁₈H₃₆)₂(OCH₂CH₂CH₂CH₂O)(OC₂H₄SO₄Na)₂.

11. The composition of claim 1, wherein the composition has the formula (n-C₁₈H₃₆)₂(OCH₂CH₂CH₂CH₂O)(OC₂H₄SO₄NO₂.

12. The composition of claim 1, wherein the composition further comprises one or more additional surfactants selected from the group consisting of anionic, cationic or non-ionic surfactants, branched alkyl benzene sulfonate, linear alkyl benzene sulfonates, alkyl toluene sulfonates, and alkyl xylene sulfonates.

13. The composition of claim 1, wherein the composition further comprises a C₁₆-C₁₈ alkyl benzene sulfonate.

14. A method of enhanced oil recovery from a hydrocarbon bearing formation or a reservoir comprising the steps of:
injecting an anionic surfactant composition of formula (I) having a general formula 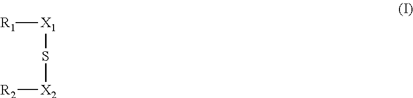
wherein R₁ and R₂ are identical or different and may independently be alkyl, alkenyl, alkynyl, alkylene, aryl, propylene oxide, ethylene oxide or hydrogen groups in a straight or branched chain with 16 or more carbon atoms, X₁ and X₂ are identical or different and are selected from the group consisting of phosphate, sulfate, carboxylate, sulfonate or other suitable anionic groups, S is a spacer group selected from short or long arkyl, alkenyl, alkynyl, alkylene, stilbene, polyethers, and other suitable aliphatic or aromatic groups comprising 2 to 12 carbon atoms, wherein the anionic surfactant composition is in water, hard water, in solutions of high salinity or hard brine; and recovering the oil following the injection of the anionic surfactant composition.

15. The method of claim 14, wherein the composition has a formula (n-C₁₈H₃₆)₂(OCH₂CH₂CH₂CH₂O)(OC₂H₄SO₄Na)₂.

16. The method of claim 14, wherein the composition has a formula (n-C₁₈H₃₆)₂(OCH₂CH₂CH₂CH₂O)(OC₂H₄SO₄NO₂.

17. The method of claim 14, wherein the reservoir has salinities of up to about 250,000 ppm.

18. The method of claim 14, wherein the reservoir has salinities of 200 ppm, 500 ppm, 1000 ppm, 5000 ppm, 10,000 ppm, 50,000 ppm, 100,000 ppm, 150,000 ppm, 250,000 ppm, 350,000 ppm.

19. The method of claim 14, wherein the reservoir has a hardness ion concentration of up to about 50,000 ppm.

20. The method of claim 14, wherein the reservoir has a hardness ion concentration of 200 ppm, 500 ppm, 1000 ppm, 5000 ppm, 10,000 ppm, 50,000 ppm.

21. The method of claim 14, wherein the anionic surfactant composition is thermally stable at reservoir temperatures of 200° C. or greater.

22. The method of claim 14, wherein the anionic surfactant composition is stable at temperatures of 50° C., 100° C., 150° C., 200° C.

23. The method of claim 14, wherein the anionic surfactant composition has a formula (n-C₁₆H₂₆)₂(CH₂OCH₂CH₂OCH₂)(OC₂H₄SO₄NO₂.

24. The method of claim 14, wherein the composition has the formula (n-C₁₈H₃₆)₂(OCH₂CH₂CH₂CH₂O)(OC₂H₄SO₄NO₂.

25. The method of claim 14, wherein the composition further comprises an alkyl benzene sulfonate.

26. The method of claim 14, wherein the composition further comprises a C₁₆-C₁₈ alkyl benzene sulfonate.

27. The method of claim 14, wherein the composition is used alone, in conjunction with a polymer, with another surfactant, or as part of an alkaline surfactant polymer (ASP) composition for treating the hydrocarbon-bearing formation.

28. A method of enhanced oil recovery from a hydrocarbon bearing formation or a reservoir comprising the steps of:
injecting an anionic surfactant composition of formula (I) having a general formula 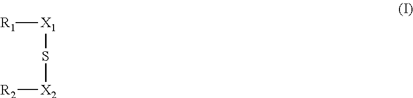
wherein R₁ and R₂ are identical or different and may independently be alkyl, alkenyl, alkynyl, alkylene, aryl, propylene oxide, ethylene oxide or hydrogen groups in a straight or branched chain with 16 or more carbon atoms, X₁ and X₂ are identical or different and are selected from the group consisting of phosphate, sulfate, carboxylate, sulfonate or other suitable anionic groups, S is a spacer group selected from short or long arkyl, alkenyl, alkynyl, alkylene, stilbene, polyethers, and other suitable aliphatic or aromatic groups comprising 2 to 12 carbon atoms, alone, in conjunction with a polymer or as an alkaline-surfactant-polymer formulation (ASP) into the hydrocarbon bearing formation at temperatures of 200° C. or greater, wherein the anionic surfactant composition is in water, hard water, in solutions of high salinity or hard brine; and
injecting a polymer “push” solution to recover the oil.

29. The method of claim 28, wherein the reservoir has salinities of up to about 250,000 ppm.

30. The method of claim 28, wherein the reservoir has a hardness ion concentration of up to about 50,000 ppm.

31. A method of enhanced oil recovery from a hydrocarbon bearing formation or a reservoir comprising the steps of:
injecting an anionic surfactant composition having a formula (n-Cᵢ₈H₃₆)₂(OCH₂CH₂ CH₂CH₂O)(OC₂H₄SO₄Na)₂ into the hydrocarbon bearing formation or reservoir, wherein the anionic surfactant composition is in water, hard water, in solutions of high salinity or hard brine; and
recovering the oil following the injection of the anionic surfactant composition.

32. The method of claim 31, wherein the reservoir has salinities of up to about 350,000 ppm.

33. The method of claim 31, wherein the reservoir has a hardness ion concentration of up to about 50,000 ppm.

34. The method of claim 31, wherein the anionic surfactant composition is thermally stable at reservoir temperatures of 200° C. or greater.

35. The method of claim 31, wherein the composition further comprises an alkyl benzene sulfonate.

36. A composition for treating a hydrocarbon bearing formation or a reservoir comprising:
an anionic surfactant composition of formula (I) 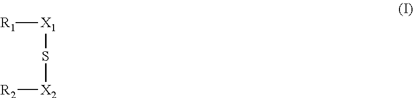
wherein R₁ and R₂ are identical or different and may independently be alkyl, alkenyl, alkynyl, alkylene, aryl, propylene oxide, ethylene oxide or hydrogen groups in a straight or branched chain with 16 or more carbon atoms, X₁ and X₂ are identical or different and are selected from the group consisting of phosphate, sulfate, carboxylate, sulfonate or other suitable anionic groups, S is a spacer group selected from short or long arkyl, alkenyl, alkynyl, alkylene, stilbene, polyethers, and other suitable aliphatic or aromatic groups comprising 2 to 12 carbon atoms; and
one or more additional surfactants selected from the group consisting of anionic, cationic or non-ionic surfactants, branched alkyl benzene sulfonate, linear alkyl benzene sulfonates, alkyl toluene sulfonates, and alkyl xylene sulfonates, wherein the anionic surfactant or formula (I), the one or more additional surfactants or both are sufficiently soluble in water, hard water, hard brine or in solutions of high salinity to be injected into a hydrocarbon-bearing formation or reservoir.

37. The composition of claim 36, wherein the composition is used to treat the reservoir with salinities of 200 ppm, 500 ppm, 1000 ppm, 5000 ppm, 10,000 ppm, 50,000 ppm, 100,000 ppm, 150,000 ppm, 250,000 ppm, 350,000 ppm.

38. The composition of claim 36, wherein the composition is used to treat the reservoir with a hardness ion concentration of 200 ppm, 500 ppm, 1000 ppm, 5000 ppm, 10,000 ppm, 50,000 ppm.

39. The composition of claim 36, wherein the composition is thermally stable at temperatures of 200° C. or greater.

40. The composition of claim 36, wherein the composition is adapted for use in enhanced oil recovery (EOR), environmental ground water cleanup, and other surfactant based applications.

41. A method of enhanced oil recovery from a hydrocarbon bearing sandstone formation or a reservoir comprising the steps of:
injecting a surfactant composition comprising an anionic surfactant composition of formula (I) 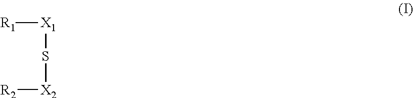
wherein R₁ and R₂ are identical or different and may independently be alkyl, alkenyl, alkynyl, alkylene, aryl, propylene oxide, ethylene oxide or hydrogen groups in a straight or branched chain with 16 to 22 carbon atoms, X₁ and X₂ are identical or different and are selected from the group consisting of phosphate, sulfate, carboxylate, sulfonate or other suitable anionic groups, S is a spacer group selected from short or long arkyl, alkenyl, alkynyl, alkylene, stilbene, polyethers, and other suitable aliphatic or aromatic groups comprising 2 to 12 carbon atoms and one or more additional surfactants selected from the group consisting of anionic, cationic or non-ionic surfactants, branched alkyl benzene sulfonate, linear alkyl benzene sulfonates, alkyl toluene sulfonates, and alkyl xylene sulfonates, wherein the anionic surfactant or formula (I), the one or more additional surfactants or both are sufficiently soluble in water, hard water, hard brine or in solutions of high salinity to be injected into a hydrocarbon-bearing formation or reservoir; and
recovering the oil following the injection of the surfactant composition.

42. The method of claim 41, wherein the reservoir has salinities of 200 ppm, 500 ppm, 1000 ppm, 5000 ppm, 10,000 ppm, 50,000 ppm, 100,000 ppm, 150,000 ppm, 250,000 ppm, 350,000 ppm.

43. The method of claim 41, wherein the reservoir has a hardness ion concentration of 200 ppm, 500 ppm, 1000 ppm, 5000 ppm, 10,000 ppm, 50,000 ppm.

44. The method of claim 41, wherein the anionic surfactant composition is thermally stable at reservoir temperatures of 200° C. or greater.

45. A method of selecting an anionic surfactant for optimal oil recovery from a hydrocarbon bearing formation or a reservoir comprising the steps of:
identifying a temperature, a salinity and a hardness ion concentration of the hydrocarbon bearing formation or the reservoir;
providing an anionic surfactant composition having a formula (I) 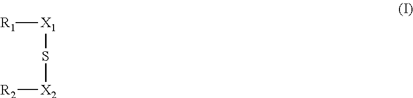
wherein R₁ and R₂ are identical or different and may independently be alkyl, alkenyl, alkynyl, alkylene, aryl, propylene oxide, ethylene oxide or hydrogen groups in a straight or branched chain with 16 to 22 carbon atoms, X₁ and X₂ are identical or different and are selected from the group consisting of phosphate, sulfate, carboxylate, sulfonate or other suitable anionic groups, S is a spacer group selected from short or long arkyl, alkenyl, alkynyl, alkylene, stilbene, polyethers, and other suitable aliphatic or aromatic groups comprising 2 to 12 carbon atoms; and
selecting an appropriate R₁, R₂, and S that would impart a suitable hydrophile-lipophile balance (HLB) to the anionic surfactant for optimal oil recovery from the hydrocarbon bearing formation or a reservoir.

46. The method of claim 45, wherein the selected anionic surfactant effectively recovers oil in reservoir salinities of 200 ppm, 500 ppm, 1000 ppm, 5000 ppm, 10,000 ppm, 50,000 ppm, 100,000 ppm, 150,000 ppm, 250,000 ppm, 350,000 ppm.

47. The method of claim 45, wherein the selected anionic surfactant effectively recovers oil in reservoir hardness ion concentrations of 200 ppm, 500 ppm, 1000 ppm, 5000 ppm, 10,000 ppm, 50,000 ppm.

48. The method of claim 45, wherein the selected anionic surfactant effectively recovers oil in reservoir temperatures of 200° C. or greater.

49. The method of claim 45, wherein the selected anionic surfactant has a formula (n-C₁₈H₃₆)₂(OCH₂CH₂CH₂CH₂O)(OC₂H₄SO₄Na)₂.

50. The method of claim 45, wherein the selected anionic surfactant has the formula (n-C₁₈H₃₆)₂(OCH₂CH₂CH₂CH₂O)(OC₂H₄SO₄NO₂.
